(19) United States
(12) Patent Application Publication
(10) Pub. No.: US 2024/0153223 A1
(43) Pub. Date: May 9, 2024

(54) Reliable Depth Measurements for Mixed Reality Rendering

(71) Applicant: Meta Platforms Technologies, LLC, Menlo Park, CA (US)

(72) Inventors: Andrey Tovchigrechko, Saratoga, CA (US); Fabian Langguth, Wädenswil (CH); Alex Locher, Oberrohrdorf (CH); Britta Hummel, Zurich (CH); Paul Timothy Furgale, Thalwil (CH); Ricardo da Silveira Cabral, Zurich (CH); Sebastian Sztuk, Virum (DK)

(21) Appl. No.: 18/504,944

(22) Filed: Nov. 8, 2023

Related U.S. Application Data
(60) Provisional application No. 63/382,870, filed on Nov. 8, 2022.

(51) Int. Cl. G06T 19/00; G06T 5/20; G06V 10/26

(52) U.S. Cl. CPC G06T 19/006; G06T 5/20; G06V 10/26

(57) ABSTRACT

In particular embodiments, a computing system may capture access a set of depth measurements and an image of a scene generated using one or more sensors of an artificial reality device. The system may generate, based on the image, a plurality of segmentation masks respectively associated with a plurality of object types. The system may segment, using the plurality of segmentation masks, the set of depth measurements into subsets of depth measurements respectively associated with the plurality of object types. The system may determine, for each object type, a three-dimensional (3D) model that best fits the subset of depth measurements corresponding to the object type. The system may refine, using 3D models determined for the plurality of object types, the subsets of depth measurements respectively associated with the plurality of object types and use refined depth measurements for mixed reality rendering.

### PRIORITY

This application claims the benefit, under 35 U.S.C. § 119(e), of U.S. Provisional Patent Application No. 63/382,870, filed 8 Nov. 2022, which is incorporated herein by reference.

### TECHNICAL FIELD

This disclosure generally relates to computer graphics, and more specifically to mixed reality rendering techniques.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content, such as a mixed reality image, may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers. “Passthrough” is a feature that allows a user to see their physical surroundings while wearing an artificial reality system. Information about the user's physical environment is visually “passed through” to the user by having the headset of the artificial reality system display information captured by the headset's external-facing cameras.

Depth information is an important component for mixed reality rendering, including passthrough rendering, occlusion rendering, etc. Depth information may be measured based on correspondence between stereo images. Alternatively, depth information may be obtained through dedicated depth sensor(s), such as time-of-flight sensors, that may be integrated within an artificial reality system. However, the depth sensors have measurement errors, low resolution, and do not work on some object types. Also, computing depth based on stereo images is prone to errors and mistakes. Due to this, measuring scene geometry for artificial reality, such as mixed reality, is generally difficult and not very accurate. This is a key problem for artificial reality devices (e.g., mixed reality devices), overcoming which defines to a large extent the commercial success of an AR/VR device.

### SUMMARY OF PARTICULAR EMBODIMENTS

Particular embodiments described herein relate to a technique for generating reliable and/or accurate depth measurements for use in downstream artificial reality applications, such as for mixed reality rendering. Specifically, the technique refines raw depth measurements (e.g., acquired from a depth sensor) by segmenting them into separate subsets of depth measurements respectively associated with a plurality of object types/categories present in a visual scene, determine three-dimensional (3D) models for the plurality of object types based on parameters associated with the object types, and refines the depth measurements using accurate object geometries defined by these 3D models for the plurality of object types, as discussed in more detail below. The refined depth measurements obtained through the technique discussed herein may be used for downstream artificial reality applications, such as mixed reality rendering. By way of an example and not limitation, the refined depth measurements may be used for passthrough rendering. As another example, the refined depth measurements may be used for occlusion detection and/or rendering.

In particular embodiments, the technique for generating refined depth measurements may begin with obtaining raw depth measurements and a brightness image. For instance, one or more sensors associated with an artificial reality device (e.g., mixed reality headset) may produce the raw depth measurements as well the brightness image. The one or more sensors may be a depth sensor, such as a time-of-flight (ToF) sensor, which may be capable of producing depth measurements and brightness image. In some embodiments, stereo images may be obtained through stereo cameras (e.g., mono stereo cameras, RGB stereo cameras) of the artificial reality device and then the depth measurements are obtained by comparing the stereo images and using triangulation techniques to compute depth. In such a scenario where stereo cameras are used, one of the stereo images associated with one eye (e.g., left eye or right eye) may simply be used as a brightness image. The depth measurements obtained using the depth sensor or based on stereo images may contain noise and may be inaccurate.

In particular embodiments, to refine the depth measurements, a plurality of object types/categories present in a visual scene may be identified. This may be done by performing a segmentation using the brightness image. In particular, segmentation may be performed on the brightness image associated with a current frame N to decompose a visual scene represented by the image into a plurality of segmentation masks corresponding to plurality of object types. Each segmentation mask identifies pixels within the image that correspond to one or more objects in the visual scene having a predetermined object type or category. For example, if the visual scene includes one or more body parts (e.g., hands, legs) of the user, background static objects (e.g., table, chair, wall art, painting, etc.), other people in the scene, and flat surfaces (e.g., walls, tables, etc.), then the segmentation may generate four masks, including a first mask corresponding to body parts (e.g., hands, legs) of the self-user, a second mask corresponding to the background static objects, a third mask corresponding to the other people in the scene, and a fourth mask corresponding to the flat surfaces.

In particular embodiments, the segmentation discussed herein may be performed using a machine learning (ML) technique. Stated differently, the segmentation may be ML-based segmentation or uses a ML model to perform the segmentation discussed herein. For instance, a ML model may be trained to identify different classes/types of objects in an image and generate masks corresponding to these different classes/types of objects. The computing system may use such a ML model to perform the segmentation to generate a plurality of segmentation masks corresponding to a plurality of object types in the visual scene. In some embodiments, a ML-based depth segmentation technique may be used to create the segmented masks or parts discussed herein in high resolution. In some embodiments, ToF based depth may be used to give “true” depth data points at a lower resolution, so that the ToF based data may be used to create a 3D scene and provide true depth measurements. In such a scenario, ML-based depth may provide segmentation.

Once the segmentation masks are obtained corresponding to the plurality of object types as discussed above, they may be used to segment the depth measurements into subsets of depth measurements respectively associated with the plurality of object types. In some embodiments, the segmentation masks may be used to segment a depth map generated from the depth measurements into a plurality of depth maps respectively associated with the plurality of object types. However, this is not necessarily required, and depth may be refined for subsets of depth measurements without needing to generate their corresponding depth maps. Each subset of depth measurements may correspond to one or more objects of a particular type in the visual scene. By way of an example and without limitation, a first subset of depth measurements may correspond to certain body parts of the user (e.g., hands), a second subset of depth measurements may correspond to planes in the scene, and a third subset of depth measurements may correspond to background static objects in the scene.

One benefit of segmenting the depth measurements based on object types is that known geometric constraints of those object types may be used to refine the depth measurements. In one embodiment, depth refinement may include refining subsets of depth measurements using one or more components that provide 3D modeling or geometric constraints for depth refinement. These components may be modules or services that detects or tracks certain object types of interest and generate 3D models for them. The 3D models generated by these components represent accurate depth information (e.g., depth measurements and/or object geometries) based on tracking different object types over a period of time. Each of these components may be configured to track a particular object type/category and generate a 3D model representative of the object geometry for that object type. By way of an example and without limitation, the components may include (1) a first component, which may be planes component including information relating to 2D planes in the visual scene and configured to generate model(s) corresponding to these planes (e.g., walls in the visual scene), (2) a second component, which may be people component including information relating to different humans in the scene and configured to generate model(s) corresponding to people in the scene and/or their individual body parts (e.g., hands, legs), and (3) a third component, which may be three-dimensional reconstruction (3DR) component including information relating to observed depth measurements or geometries of static objects in the scene accumulated over a period of time. The 3DR component may be configured to generate 3D model(s) corresponding to background static objects in the scene. In particular embodiments, the object types supported by components may correspond to the object types associated with the segmentation masks.

Each of the components may include priors (e.g., 3D models or rules) that constrain the geometry of the associated object type. For example, if component is associated with planes, the geometric constraint would be 2D planes as detected by the component. As an example, the computing system may use the planes component and its associated model(s) to refine (e.g., replace) subsets of depth measurements associated with the planes. In particular embodiments, an optimization algorithm may be used to find an arrangement of planes that would best-fit the observed depth measurements in the subset associated with planes. Depth measurements in the subset that don't match the fitted planes may be filtered out. As another example, the computing system may use the people component and its associated 3D model(s) to refine subsets of depth measurements associated with user's body parts, such as hands. More specifically, a hand tracking model provided by the people component may be used to refine the depth geometry of the user's hand. In particular embodiments, people component may include a human-body model that constrains the possible geometry of the human body. An optimization algorithm may be used to find the pose of one or more human bodies that best fit the observed depth measurements in a subset of depth measurements associated with people. The 3D fitted model of people may be used to filter out depth measurements in the subset of depth measurements that are outliers relative to the 3D fitted model of people.

In particular embodiments, an optimization algorithm may be used to generate a suitable 3D model or optimize a pre-generated model for refining a subset of depth measurements associated with a particular object type. Generating and/or optimizing a 3D model for a particular object type may be based on parameters of the object type at a current time instance. The parameters of the object type may include, for example and without limitation, shape, size, length, width, height, thickness, gesture, pose, position, etc. of the object type. By way of an example and not limitation, if a 3D model is being determined for refining subset of depth measurements corresponding to user's hand, then the computing system may first identify various features/parameters of the user's hand (e.g., how thick are user fingers, what is the shape of the user's hand, how tall is each finger, joints of each finger, etc.), selects a general hand model from a library of models, and optimizes the selected hand model according to the identified features/parameters of the user's hand. The 3D model for the user's hand generated and/or optimized this way would be able to best fit the subset of depth measurements corresponding to the user's hand.

In some embodiments, some object types/categories may be simple, and some may be complex. Simple object types may be those object types whose parameters may be physically ascertained. For example, a user's hand is a simple object type as its features/parameters have physical aspects (e.g., measurements, dimensions) associated with it. Complex object types may be those object types whose features/parameters are abstract and may not be physically ascertained. In particular embodiments, a machine learning model (e.g., variational autoencoder (VAE)) may be used to interpret such abstract parameters of the complex object types. For example, the optimization algorithm when generating and/or optimizing a 3D model for a complex object type may use the VAE to interpret features/parameters of the complex object type.

Once the 3D models are generated and/or optimized as discussed above, they may be used to perform depth refinement to generate refined depth measurements, which are relatively more reliable and accurate than the raw depth measurements (e.g., acquired from a depth sensor). In particular embodiments, depth refinement may include replacing, for each object type/category, the subset of depth measurements corresponding to the object type with depth information (e.g., object geometry) represented by the 3D model associated with that object type. By way of an example and not limitation, the subset of depth measurements corresponding to user's hand may be replaced by the hand tracking model provided by the people component. Those depth measurements that are outliers (e.g., remaining depth measurements that are left out as they are not matched or fitted to the model) are filtered out.

In particular embodiments, the resulting refined depth measurements may be used in one or more downstream artificial reality applications, such as for mixed reality rendering. For example, the refined subsets of depth measurements may be respectively converted into K depth meshes and then the K depth meshes may be used for passthrough rendering. As another example, replacing the depth measurements with 3D models would be able to better render occlusions as portions that may be missed in one or more frames (e.g., user's finger present in one frame but not present in another) may be fully captured and represented by replaced 3D models. As yet another example, the refined depth measurements represented by the 3D models would be able to better render different light reflections from object(s).

In particular embodiments, using the 3D models discussed herein to refine the raw depth measurements (e.g., replace depth measurements) is advantageous for a variety of reasons and solves several problems. For example, using the 3D models for object geometry instead of relying on depth measurements from depth sensor (that generally have some delay) may lead to faster object movements (e.g., fast hand movements). Second, occlusions may be better handled using a complete object geometry represented by a 3D model (e.g., hand model representative of entire user's hand) rather than relying on different depth maps for the left and right eyes, where a first image (left image) may show certain portions of an object but a second image (right image) may occlude those portions. Third, temporal stabilization may be achieved using the 3D models. Specifically, a stabilization filter (e.g., Kalman filter) may be applied to a 3D model for an object type to smooth out object motions and stabilize depth measurements over time. The Kalman filter may be able to adjust (e.g., transform, modify) parameters of the 3D model over time to smoothly represent object's motion (e.g., hand movements from open hand to closed first over a series of frames). Also, Kalman filter may be able to predict the object's motion at a future time instance. For example, using the Kalman filter on a hand model, velocity and acceleration of joints may be calculated and based on that future hand's gesture may be predicted. This may help to overcome the latency issue generally associated with depth measurements acquired with a depth sensor in a traditional way. Furthermore, since object motions may be calculated and/or predicted as discussed above, frame rates of capturing depth frames may be reduced to 30 frames per second (fps) and potentially to 15 fps that results in reducing the overall compute and power consumption. For example, using the model, the computing system may still be able to render the frames at a high refresh rate (e.g., 60 fps or higher) but the actual depth may be sampled at a much lower rate, such as 15 fps. The remaining depth frames may be interpolated using the object motion predicted using the Kalman filter. In some embodiments, different depth modalities may run at different framerate multiples. For example, true depth is only updated 15 hz, while segmentation is done in 60/90 hz.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example artificial reality system worn by a user, in accordance with particular embodiments.

FIG. 2 illustrates an example of a passthrough feature, in accordance with particular embodiments.

FIG. 3 illustrates the difference between images of the same scene captured by two different cameras.

FIG. 4 provides an illustration of 3D-passthrough rendering based on a 3D model of the environment.

FIG. 5 illustrates an example problem when rendering a passthrough image.

FIG. 6 illustrates another example problem when rendering a passthrough image.

FIG. 7 illustrates an example block diagram of an improved view synthesis architecture or pipeline for rendering depth-accurate passthrough images.

FIG. 8 illustrates an example source image of a visual scene including various objects and an example depth mesh that may be created for one or more specific objects of the visual scene.

FIG. 9 illustrates another example block diagram of a technique for generating reliable and/or accurate depth measurements.

FIG. 10 illustrates an example method for generating reliable and/or refined depth measurements for mixed reality rendering, in accordance with particular embodiments.

FIG. 11 illustrates an example network environment associated with an artificial reality system.

FIG. 12 illustrates an example computer system.

### DESCRIPTION OF EXAMPLE EMBODIMENTS

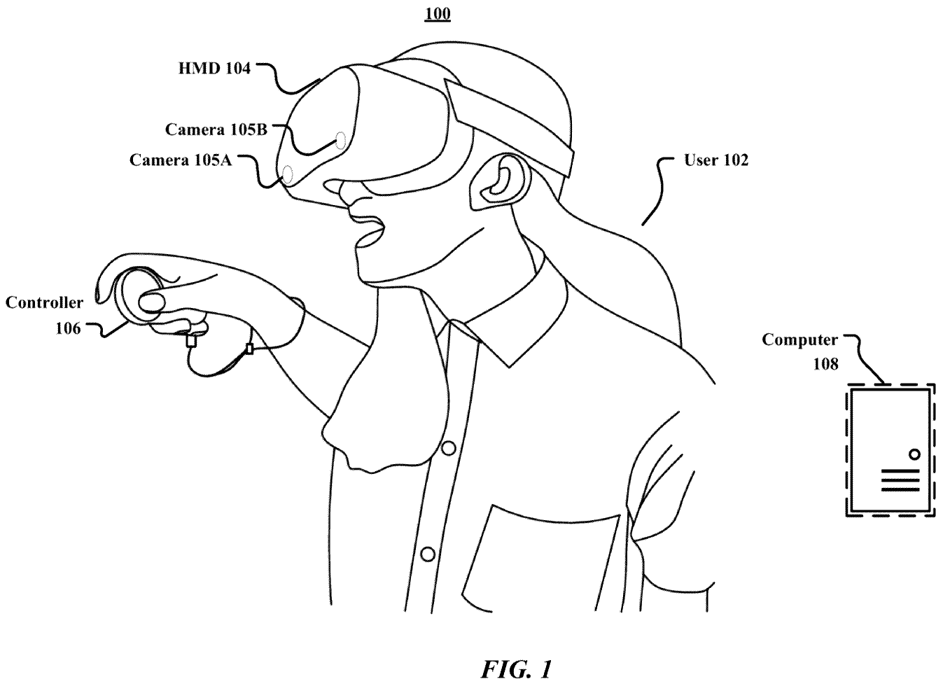

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content, such as a mixed reality image, may include completely generated content or generated content combined with captured content (e.g., real-world photographs). Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers. One example artificial reality system is shown in at least FIG. 1, which is discussed below.

“Passthrough” is a feature that allows a user to see their physical surroundings while wearing an artificial reality system, such as the artificial reality system 100 shown in FIG. 1. Information about the user's physical environment is visually “passed through” to the user by having the headset of the artificial reality system display information captured by the headset's external-facing cameras. The visual information, which may be referred to as “passthrough,” allows the user to see their physical surroundings while wearing an HMD. Information about the user's physical environment is visually “passed through” to the user by having the HMD display information captured by the headset's external-facing cameras. Simply displaying the captured images would not work as intended, however. Since the locations of the cameras do not coincide with the locations of the user's eyes, the images captured by the cameras do not accurately reflect the user's perspective. In addition, since the images have no depth, simply displaying the images would not provide the user with proper parallax effects if he were to shift away from where the images were taken. Incorrect parallax, coupled with user motion, could lead to motion sickness. Thus, to generate correct parallax and rather than simply displaying the captured images, accurate depth information of a visual scene is also needed and be combined with captured images in order to reconstruct depth-accurate passthrough images representing the visual scene from the user's current viewpoint.

FIG. 1 illustrates an example of an artificial reality system 100 worn by a user 102. In particular embodiments, the artificial reality system 100 may comprise a head-mounted device (“HMD”) 104, a controller 106, and a computing system 108. The HMD 104 may be worn over the user's eyes and provide visual content to the user 102 through internal displays (not shown). The HMD 104 may have two separate internal displays, one for each eye of the user 102. As illustrated in FIG. 1, the HMD 104 may completely cover the user's field of view. By being the exclusive provider of visual information to the user 102, the HMD 104 achieves the goal of providing an immersive artificial-reality experience.

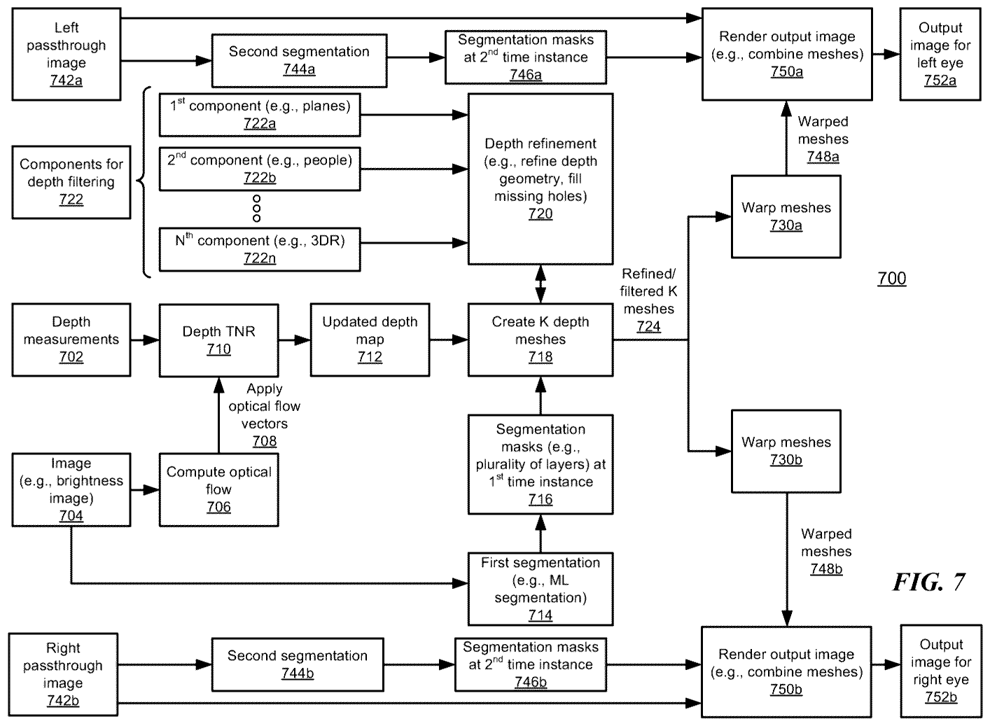

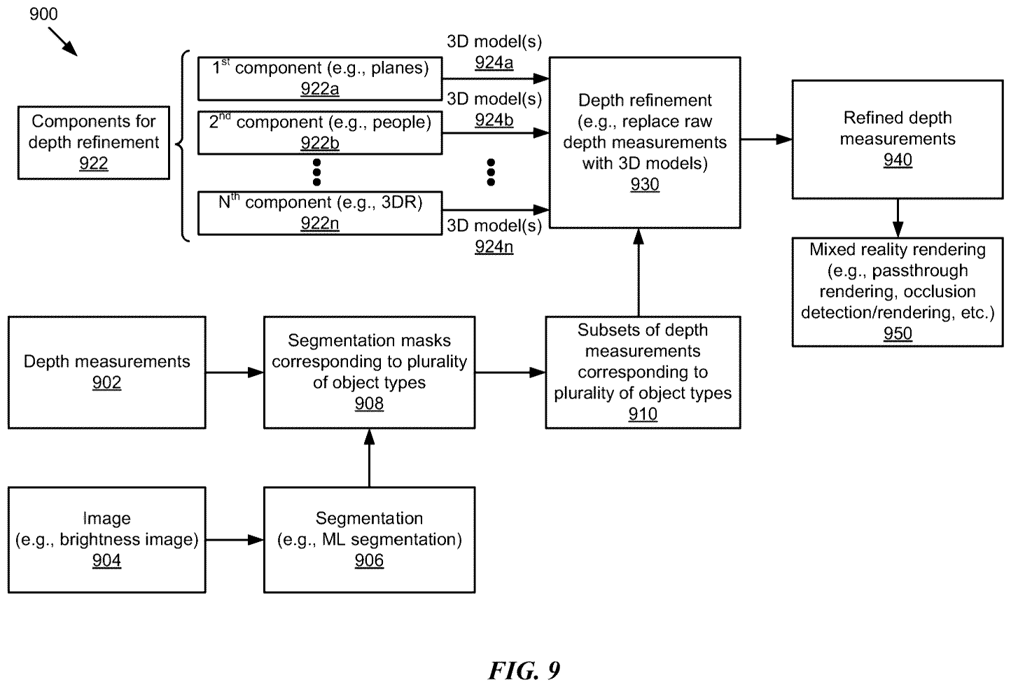

The HMD 104 may have external-facing cameras, such as the two forward-facing cameras 105A and 105B shown in FIG. 1. In particular embodiments, camera 105A may be used to capture images that will be “passed through” to the user's right eye, and camera 105B may be used to capture images that will be “passed through” to the user's left eye. While only two forward-facing cameras 105A-B are shown, the HMD 104 may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras are configured to capture the physical environment around the user and may do so continuously to generate a sequence of frames (e.g., as a video). As previously explained, although images captured by the forward-facing cameras 105A-B may be directly displayed to the user 102 via the HMD 104, doing so would not provide the user with an accurate view of the physical environment since the cameras 105A-B cannot physically be located at the same location as the user's eyes. In addition, since the images have no depth, simply displaying the images would not provide the user with proper parallax effects if he were to shift away from where the images were taken. Incorrect parallax, coupled with user motion, could lead to motion sickness. As such, accurate depth information of a visual scene or user's physical environment is also needed when rendering passthrough images. The present disclosure describes an improved view synthesis pipeline for rendering depth-accurate passthrough images. The improved view synthesis pipeline is discussed later in detail in reference to at least FIG. 7 and FIG. 9.

Three-dimensional (3D) representation may be generated based on depth measurements of physical objects observed by a depth sensor. Depth may be measured in a variety of ways. In particular embodiments, depth may be measured using a depth sensor (not shown), which may be a time-of-flight (ToF) sensor. The ToF sensor may determine the depths within its field of view by measuring the amount of time it takes for a photon to reflect back from objects in the scene. The ToF sensor may output a depth map that specifies the depth measurements within the scene and a brightness image that specifies the brightness in the scene. In particular embodiments, depth may alternatively be computed based on stereo images. For example, the two forward-facing stereo cameras may share an overlapping field of view and be configured to capture images simultaneously. As a result, the same physical object may be captured by both cameras at the same time. For example, a particular feature of an object may appear at one pixel p_{A} in the image captured by one camera, and the same feature may appear at another pixel p_{B} in the image captured by the other camera. As long as the depth measurement system knows that the two pixels correspond to the same feature, it could use triangulation techniques to compute the depth of the observed feature. For example, based on the camera's position within a 3D space and the pixel location of p_{A} relative to the camera's field of view, a line could be projected from the camera and through the pixel p_{A}. A similar line could be projected from the other camera and through the pixel p_{B}. Since both pixels are supposed to correspond to the same physical feature, the two lines should intersect. The two intersecting lines and an imaginary line drawn between the two cameras form a triangle, which could be used to compute the distance of the observed feature from either camera or a point in space where the observed feature is located. The resulting depth information may be stored using a depth map, which may be represented using a matrix of pixels, where each pixel encodes the depth of an object observed through that pixel.

In particular embodiments, the pose (e.g., position and orientation) of the HMD 104 within the environment may be needed. For example, in order to render the appropriate display for the user 102 while he is moving about in a virtual environment, the system 100 would need to determine his position and orientation at any moment. Based on the pose of the HMD, the system 100 may further determine the viewpoint of either of the cameras 105A and 105B or either of the user's eyes. In particular embodiments, the HMD 104 may be equipped with inertial-measurement units (“IMU”). The data generated by the IMU, along with the stereo imagery captured by the external-facing cameras 105A-B, allow the system 100 to compute the pose of the HMD 104 using, for example, SLAM (simultaneous localization and mapping) or other suitable techniques.

In particular embodiments, the artificial reality system 100 may further have one or more controllers 106 that enable the user 102 to provide inputs. The controller 106 may communicate with the HMD 104 or a separate computing unit 108 via a wireless or wired connection. The controller 106 may have any number of buttons or other mechanical input mechanisms. In addition, the controller 106 may have an IMU so that the position of the controller 106 may be tracked. The controller 106 may further be tracked based on predetermined patterns on the controller. For example, the controller 106 may have several infrared LEDs or other known observable features that collectively form a predetermined pattern. Using a sensor or camera, the system 100 may be able to capture an image of the predetermined pattern on the controller. Based on the observed orientation of those patterns, the system may compute the controller's position and orientation relative to the sensor or camera.

The artificial reality system 100 may further include a computer unit 108. The computer unit may be a stand-alone unit that is physically separate from the HMD 104 or it may be integrated with the HMD 104. In embodiments where the computer 108 is a separate unit, it may be communicatively coupled to the HMD 104 via a wireless or wired link. The computer 108 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 100 depends on the capabilities of its computer unit 108.

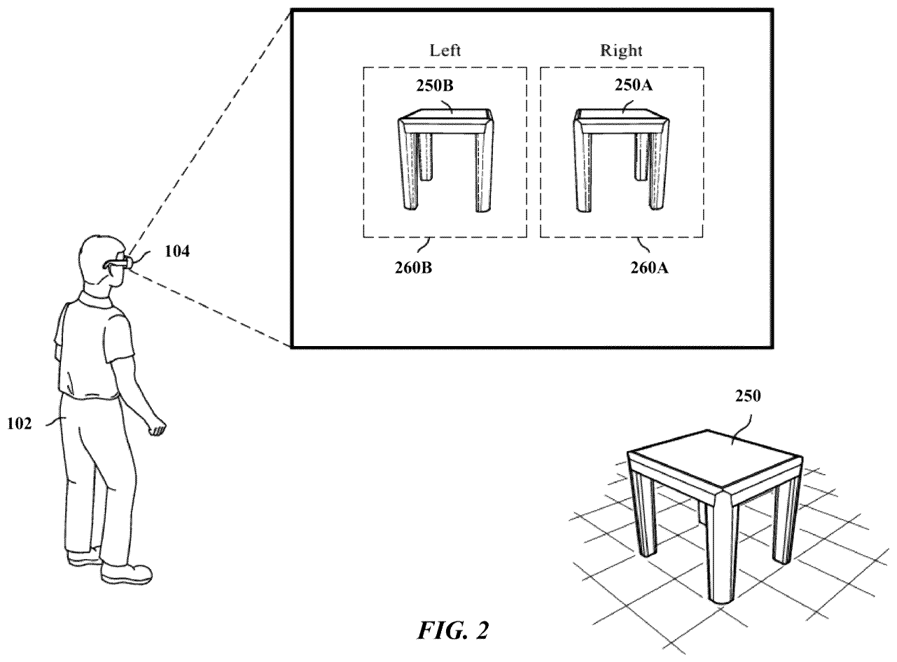

FIG. 2 illustrates an example of the passthrough feature. A user 102 may be wearing an HMD 104, immersed within a virtual reality environment. A physical table 250 is in the physical environment surrounding the user 102. However, due to the HMD 104 blocking the vision of the user 102, the user is unable to directly see the table 250. To help the user 102 perceive his physical surroundings while wearing the HMD 104, the passthrough feature captures information about the physical environment using, for example, external-facing cameras 105A-B of the HMD 104. The captured information may then be re-projected to the user 102 based on his viewpoints. In particular embodiments where the HMD 104 has a right display 260A for the user's right eye and a left display 260B for the user's left eye, the computing system 108 may individually render (1) a re-projected view 250A of the physical environment for the right display 260A based on a viewpoint of the user's right eye and (2) a re-projected view 250B of the physical environment for the left display 260B based on a viewpoint of the user's left eye.

Reprojection is performed using depth information of the scene. At a high-level, depth information encoded using a depth map or depth mesh may be treated like the 3D geometry of the scene. The images are treated like textures for the 3D geometry. Conceptually, an image captured by a camera having one viewpoint may be reprojected to another viewpoint by rendering the scene using the 3D geometry and corresponding texture.

A variety of methods may be used to capture depth information of the scene. For example, in the case of stereo depth sensors that capture stereo images, a high-performance computing unit may solve the correspondence problem using a GPU and optical flow techniques, which are optimized for determining correspondences. The correspondence information between the stereo images may then be used to compute depths using triangulation techniques. Based on the computed depths of the observed features, the computing unit could determine where those features are located within a 3D space (since the computing unit also knows where the cameras are in that 3D space). The result may be represented by a dense 3D point cloud, with each point corresponding to an observed feature. The dense point cloud may then be used to generate 3D models (e.g., a 3D depth mesh or depth map) of objects in the environment. When the system renders a scene for display, the system could perform visibility tests from the perspectives of the user's eyes. For example, the system may cast rays into the 3D space from a viewpoint that corresponds to each eye of the user. In this manner, the rendered scene that is displayed to the user would be computed from the perspective of the user's eyes, rather than from the perspective of the external-facing cameras.

Once the computing device has generated a point cloud based on the depth measurements, which may be encoded as a depth map, the depth information may be used to generate a 3D mesh representation of the observed environment. For high-performance devices, accurate models of objects in the environment may be generated (e.g., each object, such as a table or a chair, may have its own 3D model). However, for resource-limited devices, the cost of generating such models and/or the underlying depth measurements for generating the models may be prohibitive. Thus, in particular embodiments, the 3D mesh representation for the environment may be a coarse approximation of the general contour of the objects in the environment. In particular embodiments, a single 3D mesh may be used to approximate all the objects observed. Conceptually, the 3D mesh is analogous to a blanket or sheet that covers the entire observable surfaces in the environment. In particular embodiments, the mesh may be initialized to be equal-distance (e.g., 1, 2, 2.5, or 3 meters) from a viewer or camera. Since the 3D mesh is equal-distance away from the viewer, it forms a hemisphere around the user. The 3D mesh may be deformed according to the depth measurements of the observed physical objects in order to model the contour of the environment. In particular embodiments, the 3D mesh may be deformed based on the viewer's position and a point-cloud representation of the depth measurements. To determine which portion of the 3D mesh corresponds to each point in the point cloud, the computing device may cast a conceptual ray from the viewer's position towards that point. Each ray would intersect with a primitive (e.g., a triangle or other polygon) of the 3D mesh. As a result, the point of intersection on the mesh is deformed based on the depth value associated with the point through which the ray was cast. For example, if the depth measurement of the point is 2.2 meters away from the viewer, the initial 2-meter depth value associated with the point of intersection on the mesh may be changed to 2.2 meters. Once this process has been completed for each point in the point cloud, the resulting deformed mesh would represent the contour of the physical environment observed by the viewer.

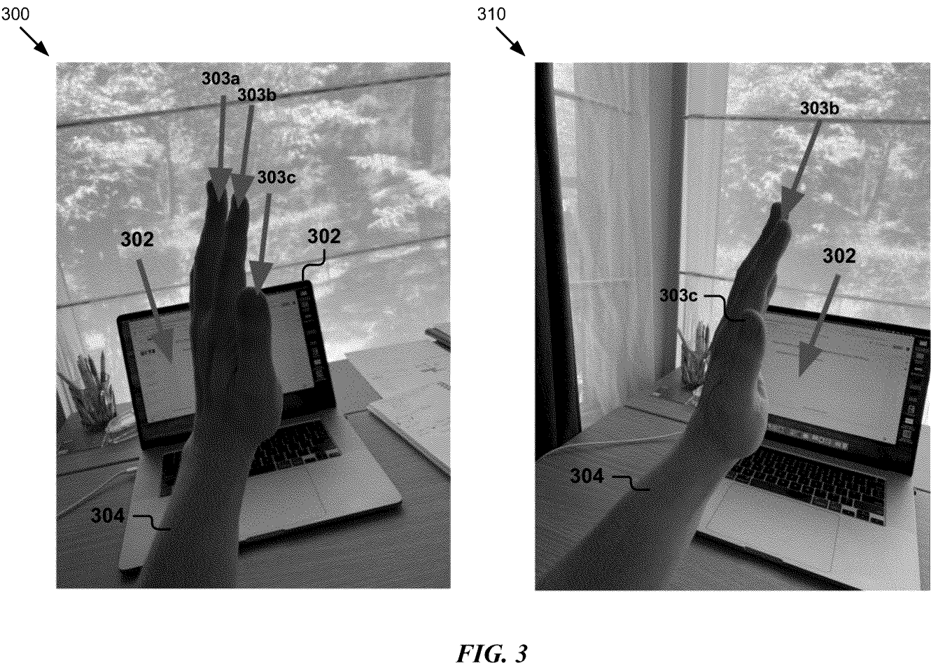

Representing the entire scene using a single mesh may be computationally efficient, but the single-mesh representation sacrifices depth accuracy, especially at the boundaries between foreground and background objects that are far apart. FIG. 3 illustrates the difference between images 300 and 310 of the same scene captured by two different cameras. As shown, even though the same scene is captured by the left and right passthrough cameras, the images 300 and 310 are significantly different due to the difference in the viewpoints of the cameras. The differences are even more pronounced when foreground objects occlude background objects. As seen, in the left image 300, the center of the laptop 302 is occluded by the user's hand 304, whereas in the right image 310, only the left portion of the laptop 302 is occluded by the hand 304. Also, in the left image 300, three fingers 303a, 303b, 303c of the user's hand 304 are clearly visible, whereas only the thumb 303c and index finger 303b are clearly visible in the right image 310. This example demonstrates that the difference between what is observed by the left and right passthrough cameras could be significant. As such, the meshes used for reprojecting the images captured by the two cameras should be generated for their respective perspectives. This is the rationale for generating a set of K meshes for the left eye and another set of K meshes for the right eye.

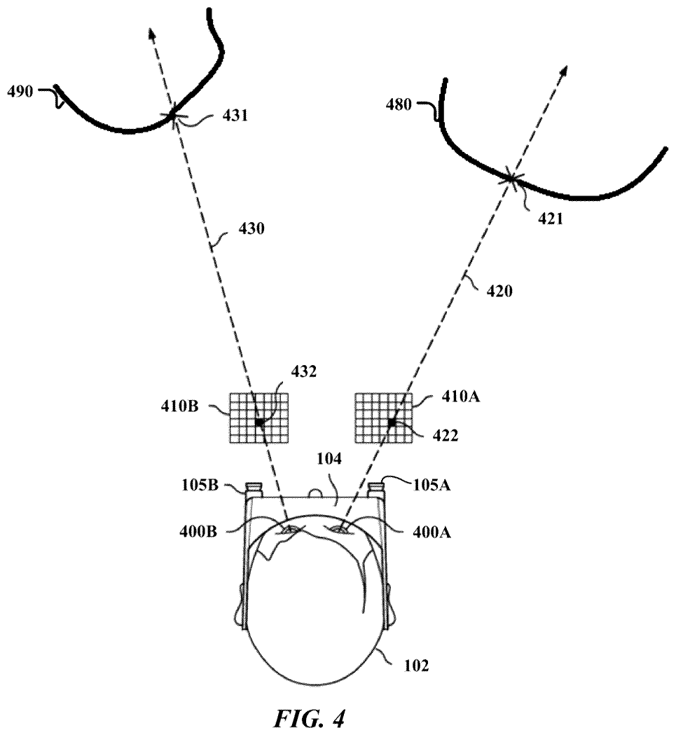

FIG. 4 provides an illustration of 3D-passthrough rendering based on a 3D model of the environment. In particular embodiments, the rendering system may determine the user's 102 current viewing position relative to the environment. In particular embodiments, the system may compute the pose of the HMD 104 using SLAM or other suitable techniques. Based on the known mechanical structure of the HMD 104, the system could then estimate the viewpoints of the user's eyes 400A and 400B using offsets from the pose of the HMD 104. The system may then render a passthrough image for each of the user's eyes 400A-B. For example, to render a passthrough image for the user's right eye 400A, the system may cast a ray 420 from the estimated viewpoint of the right eye 400A through each pixel of a virtual screen space 410A to see which portion of a 3D model would be intersected by the ray 420. This ray casting process may be referred to as a visibility test, as the objective is to determine what is visible from the selected viewpoint 400A. In the particular example shown, the ray 420 projected through a particular pixel 422 intersects with a particular point 421 on the 3D model 480. This indicates that the point of intersection 421 is to be displayed by the pixel 422. Once the point of intersection 421 is found, the rendering system may sample a corresponding point in a texture image that is mapped to the point of intersection 421. In particular embodiments, the image captured by the cameras 105A-B of the HMD 104 may be used to generate a texture for the 3D model 480. Doing so allows the rendered image to appear more like the actual physical object. In a similar manner, the rendering system may render a passthrough image for the user's left eye 400B. In the example shown, a ray 430 may be cast from the left-eye viewpoint 400B through pixel 432 of the left screen space 410B. The ray 430 intersects the 3D model 490 at location 431. The rendering system may then sample a texture image at a texture location corresponding to the location 431 on the model 490 and compute the appropriate color to be displayed by pixel 432. Since the passthrough images are re-rendered from the user's viewpoints 400A-B, the images would appear natural and provide proper parallax effect.

As discussed earlier, depth information is an important component for the passthrough rendering process. Depth information may be measured based on correspondence between stereo images. Alternatively, depth information may be obtained through dedicated depth sensor(s), such as time-of-flight sensors, that may be integrated within an artificial reality system, such as artificial reality system 100. However, the depth sensors have measurement errors, low resolution, and do not work on some object types. Also, computing depth based on stereo images is prone to errors and mistakes. Due to this, measuring scene geometry for artificial reality, such as mixed reality, is generally difficult and not very accurate. This is a key problem for artificial reality devices (e.g., mixed reality devices), overcoming which defines to a large extent the commercial success of an AR/VR device.

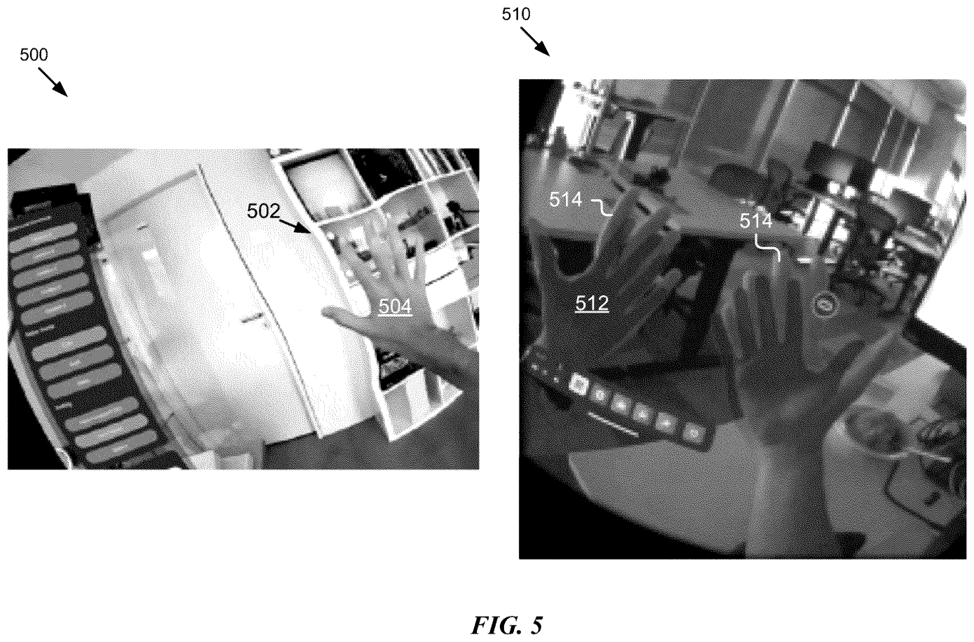

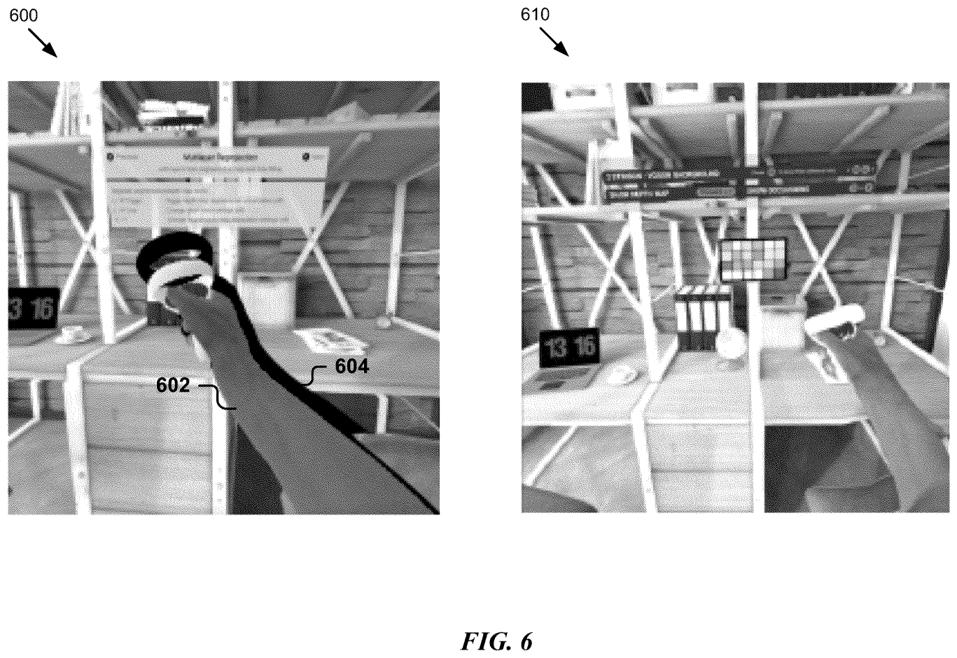

As previously mentioned, one method for representing depth information within a scene is by using a single blanket mesh. While using a single mesh may have computational benefits, it is a rough approximation of the depth in the scene and contains inaccuracies, especially at the boundaries between foreground and background objects. FIGS. 5 and 6 illustrate example problems arising when rendering passthrough images. In particular, FIG. 5 illustrates an example problem of using a single mesh to represent depths within a scene. For example, left image 500 shows that the background 502 around the user's hand 504 is deformed. This rendering artifact is due to the inaccurate depth representation between a portion of the mesh corresponding to the hand 504 and the portion corresponding to the background 502. These two portions of the mesh are connected in a single-mesh depth representation. Right image 510 shows a mismatch between the passthrough image 512 of the user's hand and the location 514 of the user's hand as determined by a hand-tracking algorithm. The mismatch observed is also attributable to inaccuracies in the mesh.

FIG. 6 illustrates another example problem when rendering a passthrough image. Close objects present a challenge because they are moving faster and inaccuracies in depth measurement would result in an inaccurate mesh representation for the entire scene. For example, the left image 600 in FIG. 6 shows a gap between the user's arm 602 and the background 604. This is an undesirable artifact that occurred because the blanket mesh that represents the scene has inaccuracies around the edges of the user's arm 602. One solution is to fill the gap area with a neural color, as shown in the right image 610. Tests have shown that good results are obtained if these transition areas are filled with distorted textures. This simplifies rendering and avoids sudden changes in brightness that can be too intrusive to the eyes.

Accordingly, there is need to generate accurate and/or reliable depth measurements when rendering passthrough images for a user immersed in artificial reality via their artificial reality system. FIG. 7 illustrates an example block diagram 700 of an improved view synthesis architecture/pipeline for rendering depth-accurate passthrough images. It should be noted that operations associated with various blocks 702-752 of the improved view synthesis pipeline may be performed by the computer unit 108 of the artificial reality system 100 or the computer system 1200. Although this disclosure describes and illustrates particular blocks of the improved view synthesis pipeline of FIG. 7 as occurring in a particular order, this disclosure contemplates any suitable blocks of the improved view synthesis pipeline of FIG. 7 occurring in any suitable order.

In particular embodiments, view synthesis is a part of the mixed reality (MR) pipeline. The improved pipeline may especially be needed with respect to rendering certain objects (e.g., hands), which have been identified as critical to provide an accurate MR experience.

As depicted, raw depth measurements 702 and an image 704 may be obtained as input to the pipeline. For instance, one or more sensors associated with an artificial reality system 100 may produce the depth measurements 702 as well the image 704. The one or more sensors may be depth sensors, such as time-of-flight sensors, which may be capable of producing depth measurements and brightness images. For instance, for each pixel, a depth sensor may produce a depth value and an amplitude signal indicative of a measure of brightness of the pixel. In some embodiments, the depth measurements 702 and the image 704 (e.g., brightness image) may be produced by a time-of-flight (ToF) sensor. For instance, the ToF sensor may send a signal out and then determine how long it takes to receive the reflection back from an object. Based on this, the ToF sensor may produce depth measurements 702 and a corresponding brightness image 704, both of which being associated with a current time. In some other embodiments, stereo images may be obtained through stereo cameras (e.g., cameras 105A-105B) of the artificial reality system 100 and then the depth measurements 702 are obtained by comparing the stereo images and using triangulation techniques to compute depth. In such a scenario where stereo cameras are used, one of the stereo images associated with one eye (e.g., left eye or right eye) may simply be used as a brightness image 704.

The raw depth measurements 702 may be represented as a depth map, which may be implemented as a two-dimensional matrix of pixels, where each pixel holds a depth measurement. As discussed elsewhere herein, depth measurements 702 may contain noise and may be inaccurate, and the depth measurements 702 from frame to frame may be independently captured and lack temporal consistency. Stated differently, two consecutive depth maps (e.g., depth maps respectively corresponding to image frame N−1 and frame N) may not be temporally consistent with respect to each other and/or may be temporally unstable. Rendering passthrough images based on such temporally unstable depth maps may lead to a lack of temporal smoothness between frames.

In particular embodiments, to temporally align the depth maps, first optical flow is computed (e.g., as indicated by block 706) using a sequence of images, including the image 704. Optical flow is a technique used to represent motion (e.g., object motion) between a sequence or series of images. In particular embodiments, computing the optical flow may include determining a correspondence between a first image (e.g., image frame N−1) and a second image (e.g., image frame N) of the sequence of images and calculating motion vectors based on this correspondence. The motion vectors may be the optical flow vectors discussed herein. Once the optical flow is computed and optical flow vectors (or motion vectors) are obtained, depth temporal noise reduction (depth TNR) 710 is performed using the optical flow to improve the temporal consistency of the depth map obtained based on the depth measurements 702. In particular embodiments, the optical flow data, which specifies pixel-level motion of objects in the scene from frame N−1 to N, may be applied to a previous depth map associated with frame N−1 to generate a predicted depth map for frame N. The predicted depth map for frame N may then be used to update and denoise the currently captured depth map obtained based on depth measurements 702 for frame N. In one example, the predicted depth map and the current depth map (e.g., depth map based on depth measurements 702) may be combined (e.g., averaged) to generate an updated or adjusted depth map 712 to be used by the rest of the pipeline. The depth map 712 produced by the TNR block 710 is temporally more stable and reduces temporal inconsistencies.

As previously mentioned, another objective of the present pipeline 700 is to represent different types of objects in the scene using different meshes. Using multiple meshes helps improve depth and edge accuracy, and grouping/categorizing depth measurements based on object allows us to leverage known geometric constraints about those object types to further refine the depth measurements. To this end, a first segmentation 714 may be performed on the image 704 (e.g., brightness image) associated with the current frame N to decompose a visual scene represented by the image 704 into a plurality of layers 716 (e.g., a plurality of segmentation masks) corresponding to different predetermined object types. Each segmentation mask identifies pixels within the image 704 that correspond to one or more objects in the visual scene having a predetermined object type or category. For example, if the visual scene includes one or more body parts (e.g., hands, legs) of the user, background static objects (e.g., table, chair, wall art, painting, etc.), and other people in the scene, then the first segmentation 714 may generate 3 layers/masks, including a first layer/mask corresponding to body parts (e.g., hands, legs) of the self-user, a second layer/mask corresponding to the background static objects, and a third layer/mask corresponding to the other people in the scene.

In particular embodiments, the segmentation 714 discussed herein may be performed using a machine learning (ML) technique. Stated differently, the segmentation may be ML-based segmentation or uses a ML model to perform the segmentation discussed herein. For instance, a ML model may be trained to identify different classes/types of objects in an image and generate image layers/masks corresponding to these different classes/types of objects. The computing system (e.g., the computer 108 or the computer system 1200) may use such a ML model to perform the first segmentation 714 to generate a plurality of segmentation layers/masks 716 corresponding to a plurality of predetermined object types in the visual scene.

In particular embodiments, K depth meshes 718 may be created from the temporally aligned depth map 712 (or optionally, if TNR is not performed, an original depth map output by the depth sensor), using the plurality of segmentation masks 716 (e.g., segmentation layers). Each depth mesh 718 may correspond to one or more objects of a particular type in the visual scene. In particular embodiments, to create a particular mesh 718 corresponding to objects of a particular type (e.g., the user's body), the segmentation layer/mask 716 associated with that object type may be used to extract depth measurements/points from the depth map 712. The extracted portion of the depth map represent depth measurements that likely correspond to the object type of interest. A 3D mesh is then created based on the extracted depth points or point cloud corresponding to the one or more objects of the desired type (e.g., hands). This process may repeat for each segmentation mask 716 to generate a plurality of meshes corresponding to different object types. By way of an example and without limitation, a first mesh may be made only from points corresponding to certain body parts of the user (e.g., hands), a second mesh may be made only from points corresponding to planes, and a third mesh may be made from all other depth points. Stated differently, three meshes may be created in this example, where mesh #1 includes only the user's arms and other observable body parts, mesh #2 includes visible planes in the scene, and mesh #3 includes all other objects in the scene. As another example, if there are K segmentation masks 716 that are generated based on the first segmentation 714 as discussed above, then there may be K depth meshes generated corresponding to these K segmentation masks, where a first depth mesh may correspond to one or more body parts (e.g., hands, legs) of a user wearing the artificial reality device, a second depth mesh may correspond to planes in the visual scene, and a third depth mesh may correspond to background static objects (e.g., table, chair, wall arts, paintings, etc.).

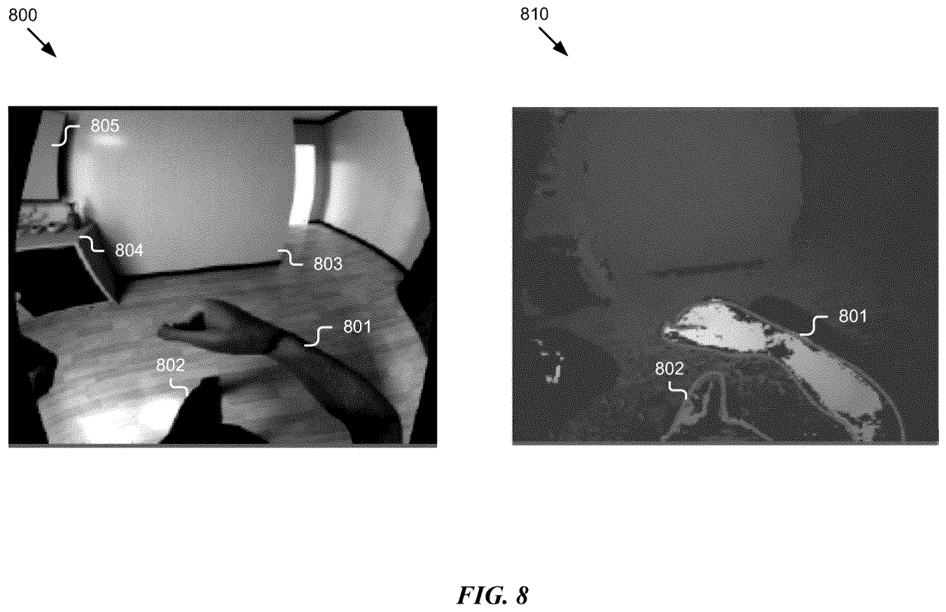

FIG. 8 illustrates an example source image 800 (an example of image 704 shown in FIG. 7) of a visual scene including various objects. A segmentation mask may be generated for the user's body, and another segmentation mask may be generated for the background. The source image 800 may be captured using an external-facing camera (e.g., cameras 105A or 105B) of the artificial reality system 100. As depicted, the image 800 shows user's body parts, such as hand 801 and leg 802, and other objects in the scene, such as wall 803, table 804, and whiteboard 805. Pixels corresponding to the hand 801 and leg 802 may be identified by a first segmentation mask, and pixels corresponding to the background, including the wall 802, table 804, and whiteboard 805 may be identified by a second segmentation mask. The image 810 conceptually illustrates the two segmentation masks applied to a depth map. The first segmentation mask associated with the user's body may be overlaid over the depth map to identify depth measurements/points that correspond to the user's hand 801 and leg 802. Similarly, the second segmentation mask may identify other depth measurements/points that correspond to the background environment.

In particular embodiments, depth measurements extracted from the depth map 712 using the K segmentation masks 716 may be refined/filtered before generating the K meshes 718. Referring back to FIG. 7, the refinement or filtering process is represented by block 720. In some embodiments, depth refinement 720 may include filling missing holes or depth information in a sparse depth map. For instance, a segmented depth map associated with a particular object type may include missing depth information because some portion of the depth map's field of view were occluded or occupied by other types of objects. For instance, foreground object(s) may occlude and/or deform background object(s). Thus, the segmented depth map for the background would have missing depth information previously occupied by depth measurements of the foreground objects. In such scenarios, the computing system discussed herein may fill-in these missing holes or pieces of information using any suitable filtering technique to densify the depth map. In particular embodiments, a Laplacian filter may be used to populate these missing holes or pieces of information. The densified segmented depth map (i.e., all the pixels within the map's field of view have depth values) may then be used to generate a corresponding mesh.

As previously mentioned, one benefit of segmenting the depth measurements based on known object types is that known geometric constraints of those object types may be used to refine the depth measurements. In one embodiment, depth refinement 720 may include refining depth measurements using one or more components 722a, 722b, . . . , 722n (individually and/or collectively referred to as 722) that provide 3D modeling or geometric constraints for depth filtering. These components 722 may be modules or services that detects or tracks certain object types of interest and generate 3D meshes for them. By way of an example and without limitation, the one or more components 722 may include (1) a first component 722a, which may be planes component including information relating to two-dimensional (2D) planes in the visual scene, (2) a second component 722b, which may be people component including information relating to different humans in the scene, and (3) a third component 722n, which may be three-dimensional reconstruction (3DR) component including information relating to observed depth measurements or geometries of static objects in the scene accumulated over a period of time. In particular embodiments, the object types supported by components 722 may correspond to the object types associated with the segmentation masks 716.

Each of the components 722 may include priors (e.g., 3D models or rules) that constrain the geometry of the associated object type. For example, if component 722a is associated with planes, the geometric constraint would be 2D planes as detected by the component 722a. As an example, the computing system may use the planes component (e.g., component 722a) to refine depth measurements within the segmented depth map associated with planes (i.e., the referenced segmented depth map may be generated by extracting depth measurements from the depth map 712 using a segmentation mask 716 associated with planes). In particular embodiments, an optimization algorithm may be used to find an arrangement of planes that would best-fit the observed depth measurements in the segmented depth map associated with planes. Depth measurements in the segmented depth map that don't match the fitted planes may be filtered out. In another embodiment, component 722a may have independently detected planes in the scene and created corresponding meshes to represent them. If so, the refinement 720 may occur at the mesh-level instead of at the depth-map level. For example, after the segmented depth map for planes have been used to create a mesh for planes, portions of the mesh for planes may be replaced by the 3D model of planes independently generated by component 722a.

As another example, the system may use the people component (e.g., component 722b) to refine the depth measurements corresponding to people in the visual scene. In particular embodiments, component 722b may include a human-body model that constrains the possible geometry of the human body. An optimization algorithm may be used to find the pose of one or more human bodies that best fit the observed depth measurements in a segmented depth map associated with people (i.e., the referenced segmented depth map is generated using the segmentation mask associated with people). The 3D fitted model of people may be used to filter out depth measurements in the segmented depth map that are outliers relative to the 3D fitted model of people. After filtering, the resulting segmented depth map may be used to generate a single mesh to represent any number of people in the scene. In other embodiments, depth refinement 720 may include replacing portions of the depth mesh for people generated from a corresponding segmented depth map using the 3D mesh of people generated independently by component 722b.

Once the one or more depth refinements 720 are applied, the resulting refined/filtered K meshes 724 may be saved and kept separate until they are combined at rendering time. At rendering time, a left passthrough image 742a and a right passthrough image 742b may be obtained from sensors of the artificial reality system. For example, left and right passthrough images may be captured by external cameras 105A-105B of the artificial reality system. These captured images 742a and 742b may represent the visual scene or user's physical environment at a current time instance (or second-time instance). However, these captured images 742a and 742b do not include depth. Accurate depth information may need to be obtained for these captured images 742a-b in order to render depth-accurate passthrough images for both eyes from a user's perspective.

In particular embodiments, the captured images 742a and 742b at the current time instance (or second-time instance) associated with passthrough-image generation may be different from the image 704 that was captured by the one or more sensors at a previous time instance (or first-time instance) associated with depth generation. For instance, there may be some time delay between an image 704 captured at the previous time instance and the image (e.g., left passthrough image 742a or right passthrough image 742b) captured at the current time instance and due to this, the objects (e.g., user's hands, other people, etc.) in the visual scene at the current time instance may be relatively at different positions than the objects in the image at the previous time instance. Due to the time delay and/or different positionings of the objects in the visual scene, the refined K meshes 724 may need to be warped and then combined in order to render an output image from a user's current eye perspective. The process for rendering a depth-accurate passthrough image for each eye is discussed in detail below.

To render a depth-accurate passthrough image for each eye, a second segmentation (e.g., ML segmentation) 744a-b may be performed on each of the left passthrough image 742a and the right passthrough image 742b. For instance, the second segmentation 744a may be performed on the left passthrough image 742a to decompose the left passthrough image 742a into a plurality of segmentation masks/layers 746a at the current or second-time instance. Each of these masks 746a may identify pixels in the left passthrough image 742a that correspond to a particular object type of interest, similar to the types identified by the first segmentation process 714. Similarly, the second segmentation 744b may be performed on the right passthrough image 742b to decompose the right passthrough image 742b into a plurality of masks/layers 746b at the current or second-time instance. Each mask of the plurality of masks 746b may correspond to one or more objects of a particular type in the visual scene at the second-time instance. As mentioned earlier, positions of objects in the scene at the second-time instance may be different from the positions of the objects in the previous or first-time instance. This may be due to the time delay between the capture of the segmentation images 742a-b and the brightness image 704. Also, the scene at the second time instance may change due to the user's eye or head position being changed (e.g., the user is now looking at a slightly different angle than before). In addition, the sensors used to capture passthrough images 742a-b may be different from the sensor used to capture brightness image 704. As such, the second segmentation 744a-b process needs to process the passthrough images 742a-b to identify where the objects of interest are within those images 742a-b.

The passthrough images 742a-b will be re-projected to the eye positions of the user. To do so, depth information corresponding to the geometry of the scene is also needed. In particular embodiments, the refined K meshes 724 may need to be warped for each eye. Specifically, in block 730a, the K meshes 724, which were generated based on depth information obtained from the perspective of a depth sensor, are warped so that they represent depth information as observed from the perspective of the left passthrough camera at the second time instance. The warping process would take into account the change in the head pose of the artificial reality device and the extrinsic and intrinsic parameters of the left passthrough camera. The resulting warped meshes 748a would be left eye-specific. Similarly, in block 730b, the K meshes 724 are warped to represent depth information as observed from the perspective of the right passthrough camera at the second time instance. The resulting warped meshes 748b would be right eye-specific. In doing so, the warped meshes 748a-b would provide proper depth information that is aligned with the passthrough images 742a-b, respectively.

Once the meshes are warped for each eye in blocks 730a and 730b, an output image may be rendered for each eye. For instance, in the render block 750a for the left eye, the computing system may composite the K warped meshes 748a for the left eye to generate a single mesh in preparation for rendering. Portions of the K warped meshes 748a may be combined to form a single final mesh according to the segmentation masks 746a associated with the left eye. Similarly, in the render block 750b for the right eye, portions of the K warped meshes 748b may be combined to form another final mesh for the right eye according to the segmentation masks 746b associated with the right eye. In particular embodiments, the rendering in blocks 750a and 750b may include mapping, associating, co-relating, and/or matching each warped mesh 748a-b with their respective segmentation information 746a-b. By way of an example and without limitation, the warped mesh 748a corresponding to body parts of the user is mapped with the segmentation layer/mask 746a associated with body parts of the user. As another example, the warped mesh 748b corresponding to background static objects is mapped with the segmentation layer/mask 746b associated with background static objects. Based on such mappings or correspondences between the warped meshes 730a-b and their respective segmentation layers/masks 746a-b, the computing system could generate composite final meshes for rendering the output images for the left and right eyes. For example, the K segmentation masks 746a for the left eye would be used to extract and combine portions of the corresponding warped meshes 748a to form a final eye-specific mesh for the left eye. This final eye-specific mesh would serve as the geometry information associated with the left passthrough image 742a. The geometry information and the passthrough image 742a may then be used by a rendering engine to render a final output image 752a for the left eye. The viewpoint used for rendering the output image 752a may be a predicted viewpoint of the user's left eye. In a similar manner, the final eye-specific mesh for the right eye and the right passthrough image 742b may be used to render an output image 752b for the right eye. These output images 752a-b may then be respectively output on a left and right eye display of the artificial reality device to give the user a “passthrough” view of the physical environment.

In some embodiments, only meshes corresponding to objects that are currently visible in the left passthrough image 742a and the right passthrough image 742b may be used during the rendering in blocks 750a and 750b. For example, if three meshes were created, where mesh #1 includes only the user's bare hands, mesh #2 includes all other objects in the scene except for the user's bare hands, and mesh #3 includes all objects in the scene, then rendering may be carried out in following rendering modes. In an example first rendering mode, if the user's hands are not visible, then only mesh #3 is used, the same for the left and right eyes. In an example second rendering mode, if the user's hands are visible and there are no objects in the hands and there are no clothes on the hands, then separate meshes are made for the left and right eyes. For this, mesh #1 and mesh #2 may be combined separately for each eye using separate segmentation masks for each eye. In an example third rendering mode, if the user's hands are visible but have objects or clothing, then a combination of first and second rendering modes above may be used. Namely, the areas where the hands have objects or clothes are marked with a fallback behavior mask and rendering takes place in them as in the first rendering mode. And on those parts of the hands that are far from clothes and objects, rendering occurs as in the second rendering mode. The fallback behavior mask may have blurry edges to make the transition between modes smooth. The fallback behavior mask may be stabilized similarly to depth TNR, namely a) the mask may be represented as an image in the range 0-1, b) motion vectors may be used to overlay the fallback behavior mask of this and the previous frame, and c) the previous fallback behavior mask may be averaged with the current one.

In particular embodiments, the output images 752a and 752b that are generated from the render blocks 750a and 750b, respectively, are depth-accurate passthrough images. Each of the output images 752a and 752b may be presented for display on a display component of an artificial reality device, such as the HMD 104 of the artificial reality system 100.

FIG. 9 illustrates another example block diagram 900 of a technique for generating reliable and/or accurate depth measurements, such as refined depth measurements 940. These refined depth measurements 940 obtained through the technique of FIG. 9 may be used for downstream artificial reality applications, such as mixed reality rendering. By way of an example and not limitation, the refined depth measurements may be used for passthrough rendering, or more specifically, for generating depth-accurate passthrough images, as discussed above in reference to FIG. 7. As another example, the refined depth measurements 940 may be used for occlusion detection and/or rendering. More specifically, the refined depth measurements may be used to resolve the problems associated with occlusions, as discussed above in reference to FIG. 3.

It should be noted that operations associated with various blocks 902-950 of the block diagram 900 may be performed by the computer unit 108 of the artificial reality system 100 or the computer system 1200. Although this disclosure describes and illustrates particular blocks 902-950 as occurring in a particular order, this disclosure contemplates any suitable blocks 902-950 occurring in any suitable order.

As depicted, raw depth measurements 902 and an image 904 may be obtained as input to a computing system, such as computing system 1200. For instance, one or more sensors associated with an artificial reality system 100 may produce the depth measurements 902 as well the image 904. The one or more sensors may be depth sensors, such as time-of-flight sensors, which may be capable of producing depth measurements and brightness images. For instance, for each pixel, a depth sensor may produce a depth value and an amplitude signal indicative of a measure of brightness of the pixel. In some embodiments, the depth measurements 902 and the image 904 (e.g., brightness image) may be produced by a time-of-flight (ToF) sensor. For instance, the ToF sensor may send a signal out and then determine how long it takes to receive the reflection back from an object. Based on this, the ToF sensor may produce depth measurements 902 and a corresponding brightness image 904, both of which being associated with a current time. In some other embodiments, stereo images may be obtained through stereo cameras (e.g., cameras 105A-105B) of the artificial reality system 100 and then the depth measurements 902 are obtained by comparing the stereo images and using triangulation techniques to compute depth. In such a scenario where stereo cameras are used, one of the stereo images associated with one eye (e.g., left eye or right eye) may simply be used as a brightness image 904. The stereo cameras (e.g., cameras 105A-105B) may be mono stereo cameras or RGB stereo cameras. In some embodiments, the depth measurements 902 and the image 904 may be obtained in an RGB+D image format for an image frame captured through one or more sensors of the artificial reality system discussed herein. The RGB+D image format may include a RGB image (e.g., image 904) and a depth map comprising the depth measurements 902 for each frame captured through the one or more sensors of the artificial reality system.

In some embodiments, although not necessarily required, the raw depth measurements 902 may be represented as a depth map. The depth map may be implemented as a two-dimensional matrix of pixels, where each pixel holds a depth measurement. As discussed elsewhere herein, the raw depth measurements 902 may contain noise and may be inaccurate, and the depth measurements 902 from frame to frame may be independently captured and lack temporal consistency. Performing mixed reality rendering (e.g., passthrough rendering, occlusion rendering, etc.) based on such noisy or inaccurate depth measurements may be prone to errors. Particular embodiments discussed herein refines these raw depth measurements 902 by segmenting them into separate subsets of depth measurements respectively associated with different object types/categories present in a scene, determine 3D models for these different object types, and refines the depth measurements using accurate object geometry defined by these 3D models for the different object types, as discussed in more detail below.

The technique for refining the depth measurements 902 may begin with first identifying a plurality of object types present in a scene. This may be done by performing a segmentation 906 using the image 904. In particular, segmentation 906 may be performed on the image 904 (e.g., brightness image) associated with a current frame N to decompose a visual scene represented by the image 904 into a plurality of segmentation masks 908 corresponding to different predetermined object types. Each segmentation mask identifies pixels within the image 904 that correspond to one or more objects in the visual scene having a predetermined object type or category. For example, if the visual scene includes one or more body parts (e.g., hands, legs) of the user, background static objects (e.g., table, chair, wall art, painting, etc.), other people in the scene, and flat surfaces (e.g., walls, tables, etc.), then the segmentation 906 may generate 4 masks, including a first mask corresponding to body parts (e.g., hands, legs) of the self-user, a second mask corresponding to the background static objects, a third mask corresponding to the other people in the scene, and a fourth mask corresponding to the flat surfaces.

In particular embodiments, the segmentation 906 discussed herein may be performed using a machine learning (ML) technique. Stated differently, the segmentation may be ML-based segmentation or uses a ML model to perform the segmentation discussed herein. For instance, a ML model may be trained to identify different classes/types of objects in an image and generate image layers/masks corresponding to these different classes/types of objects. The computing system (e.g., the computer 108 or the computer system 1200) may use such a ML model to perform the segmentation 906 to generate a plurality of segmentation masks 908 corresponding to a plurality of object types in the visual scene. In some embodiments, a ML-based depth segmentation technique may be used to create the segmented masks or parts discussed herein in high resolution. In some embodiments, ToF based depth may be used to give “true” depth data points at a lower resolution, so that the ToF based data may be used to create a 3D scene and provide true depth measurements. In such a scenario, ML-based depth may provide segmentation.

Once the plurality of segmentation masks 908 are obtained corresponding to the plurality of object types as discussed above, they may be used to segment the depth measurements 902 into subsets of depth measurements 910 respectively associated with the plurality of object types. Although not shown, the segmentation masks 908 may be used to segment a depth map generated from the depth measurements 902 into a plurality of depth maps respectively associated with the plurality of object types. However, this is not necessarily required, and depth may be refined for subsets of depth measurements 910 without needing to generate their corresponding depth maps. Each subset of depth measurements 910 may correspond to one or more objects of a particular type in the visual scene.

In particular embodiments, to obtain a subset of depth measurements 910 corresponding to object(s) of a particular type (e.g., the user's hand), the segmentation mask 908 associated with that object type may be used to extract depth measurements that likely correspond to the object type of interest. A subset of depth measurements is then created based on the extracted depth points or measurements corresponding to the one or more objects of the desired type (e.g., hands). This process may repeat for each segmentation mask 908 to generate subsets of depth measurements corresponding to different object types. By way of an example and without limitation, a first subset of depth measurements may be made only from measurements corresponding to certain body parts of the user (e.g., hands), a second subset of depth measurements may be made only from measurements corresponding to planes, and a third subset of depth measurements may be made from all other measurements. Stated differently, three subsets of depth measurements may be created in this example, where the first subset includes depth measurements corresponding to only the user's arms, the second subset includes depth measurements corresponding to visible planes (e.g., wall) in the scene, and the third subset includes depth measurements corresponding to all other objects in the scene. As another example, if there are 5 segmentation masks 908 that are generated for 5 objects in the scene, including user's hand, a chair, a table, another user, and a wall, then there may be 5 subsets of depth measurements created corresponding to these 5 segmentation masks, where a first subset of depth measurements may correspond to the user's hand, a second subset of depth measurements may correspond to the chair, a third subset of depth measurements may correspond to the table, a fourth sub set of depth measurements may correspond to another user in the scene, and the fifth subset of depth measurements may correspond to the wall.

As previously mentioned, one benefit of segmenting the depth measurements based on object types is that known geometric constraints of those object types may be used to refine the depth measurements. The refinement process is represented by block 930. In one embodiment, depth refinement 930 may include refining subsets of depth measurements 910 using one or more components 922a, 922b, . . . , 922n (individually and/or collectively referred to as 922) that provide 3D modeling or geometric constraints for depth refinement. These components 922 may be modules or services that detects or tracks certain object types of interest and generate 3D models for them. The 3D models generated by these components 922 represent accurate depth information (e.g., depth measurements and/or object geometries) based on tracking different object types over a certain period of time. Each of these components 922 may be configured to track a particular object type/category and generate a 3D model representative of the object geometry for that object type. By way of an example and without limitation, the components 922 may include (1) a first component 922a, which may be planes component including information relating to 2D planes in the visual scene and configured to generate 3D model(s) 924a corresponding to these 2D planes (e.g., walls in the visual scene), (2) a second component 922b, which may be people component including information relating to different humans in the scene and configured to generate 3D model(s) 924b corresponding to people in the scene and/or their individual body parts (e.g., hands, legs), and (3) a third component 922n, which may be three-dimensional reconstruction (3DR) component including information relating to observed depth measurements or geometries of static objects in the scene accumulated over a period of time. The 3DR component 922n may be configured to generate 3D model(s) 924n corresponding to background static objects in the scene. In particular embodiments, the object types supported by components 922 may correspond to the object types associated with the segmentation masks 908.

Each of the components 922 may include priors (e.g., 3D models or rules) that constrain the geometry of the associated object type. For example, if component 922a is associated with planes, the geometric constraint would be 2D planes as detected by the component 922a. As an example, the computing system may use the planes component (e.g., component 922a) and its associated 3D model(s) (e.g., model 924a) to refine (e.g., replace) subsets of depth measurements associated with the planes. In particular embodiments, an optimization algorithm may be used to find an arrangement of planes that would best-fit the observed depth measurements in the subset associated with planes. Depth measurements in the subset that don't match the fitted planes may be filtered out. As another example, the computing system may use the people component (e.g., component 922b) and its associated 3D model(s) (e.g., model 924b) to refine subsets of depth measurements associated with user's body parts, such as hands. More specifically, a hand tracking model provided by the people component may be used to refine the depth geometry of the user's hand. In particular embodiments, component 922b may include a human-body model that constrains the possible geometry of the human body. An optimization algorithm may be used to find the pose of one or more human bodies that best fit the observed depth measurements in a subset of depth measurements associated with people. The 3D fitted model of people may be used to filter out depth measurements in the subset of depth measurements that are outliers relative to the 3D fitted model of people.

In particular embodiments, an optimization algorithm may be used to generate a suitable 3D model or optimize a pre-generated model for refining a subset of depth measurements associated with a particular object type. Generating and/or optimizing a 3D model for a particular object type may be based on parameters of the object type at a current time instance. The parameters of the object type may include, for example and without limitation, shape, size, length, width, height, thickness, gesture, pose, position, etc. of the object type. By way of an example and not limitation, if a 3D model is being determined for refining subset of depth measurements corresponding to user's hand, then the computing system may first identify various features/parameters of the user's hand (e.g., how thick are user fingers, what is the shape of the user's hand, how tall is each finger, joints of each finger, etc.), selects a general hand model from a library of models, and optimizes the selected hand model according to the identified features/parameters of the user's hand. The 3D model for the user's hand generated and/or optimized this way would be able to best fit the subset of depth measurements corresponding to the user's hand.

In some embodiments, some object types/categories may be simple, and some may be complex. Simple object types may be those object types whose parameters may be physically ascertained. For example, a user's hand is a simple object type as its features/parameters have physical aspects (e.g., measurements, dimensions) associated with it. Complex object types may be those object types whose features/parameters are abstract and may not be physically ascertained. In particular embodiments, a machine learning model (e.g., variational autoencoder (VAE)) may be used to interpret such abstract parameters of the complex object types. For example, the optimization algorithm when generating and/or optimizing a 3D model for a complex object type may use the VAE to interpret features/parameters of the complex object type.

Once the 3D models 924a, 924b, . . . , 924n are generated and/or optimized as discussed above, they may be used to perform depth refinement 930 to generate refined depth measurements 940, which are relatively more reliable and accurate than the raw depth measurements 902. In particular embodiments, depth refinement 930 may include replacing, for each object type/category, the subset of depth measurements corresponding to the object type with depth information (e.g., object geometry) represented by the 3D model associated with that object type. By way of an example and not limitation, the subset of depth measurements corresponding to user's hand may be replaced by the hand tracking model provided by the people component (e.g., component 922b). Those depth measurements that are outliers (e.g., remaining depth measurements that are left out as they are not matched or fitted to the model) are filtered out.

In particular embodiments, the resulting refined depth measurements 940 may be used in one or more downstream artificial reality applications, such as for mixed reality rendering 950. For example, the refined subsets of depth measurements 940 may be respectively converted into K depth meshes (e.g., K depth meshes 718) and then the K depth meshes may be used for passthrough rendering, as discussed above in reference to FIG. 7. As another example, replacing the depth measurements with 3D models would be able to better render occlusions as portions that may be missed in one or more frames (e.g., user's finger present in one frame but not present in another) may be fully captured and represented by replaced 3D models. As yet another example, the refined depth measurements 940 represented by the 3D models would be able to better render different light reflections from object(s).

In particular embodiments, using the 3D models discussed herein to refine the raw depth measurements (e.g., replace depth measurements) is advantageous for a variety of reasons and solves several problems. For example, using the 3D models for object geometry instead of relying on depth measurements from depth sensor (that generally have some delay) may lead to faster object movements (e.g., fast hand movements). Second, occlusions may be better handled using a complete object geometry represented by a 3D model (e.g., hand model representative of entire user's hand) rather than relying on different depth maps for the left and right eyes, where a first image (left image) may show certain portions of an object but a second image (right image) may occlude those portions, as shown and discussed, for example, in reference to FIG. 3. Third, temporal stabilization may be achieved using the 3D models. Specifically, a stabilization filter (e.g., Kalman filter) may be applied to a 3D model for an object type to smooth out object motions and stabilize depth measurements over time. The Kalman filter may be able to adjust (e.g., transform, modify) parameters of the 3D model over time to smoothly represent object's motion (e.g., hand movements from open hand to closed first over a series of frames). Also, Kalman filter may be able to predict the object's motion at a future time instance. For example, using the Kalman filter on a hand model, velocity and acceleration of joints may be calculated and based on that future hand's gesture may be predicted. This may help to overcome the latency issue generally associated with depth measurements acquired with a depth sensor in a traditional way. In some embodiments, for the background static objects, the delay does not really matter. For fast moving or dynamic objects (e.g., hands), since the segmentation is updated with low latency, the delay in determining the distance to the objects is not significant. Furthermore, since object motions may be calculated and/or predicted as discussed above, frame rates of capturing depth frames may be reduced to 30 frames per second (fps) and potentially to 15 fps that results in reducing the overall compute and power consumption. For example, using the model, the computing system may still be able to render the frames at a high refresh rate (e.g., 60 fps or higher) but the actual depth may be sampled at a much lower rate, such as 15 fps. The remaining depth frames may be interpolated using the object motion predicted using the Kalman filter. In some embodiments, different depth modalities may run at different framerate multiples. For example, true depth is only updated 15 hz, while segmentation is done in 60/90 hz.

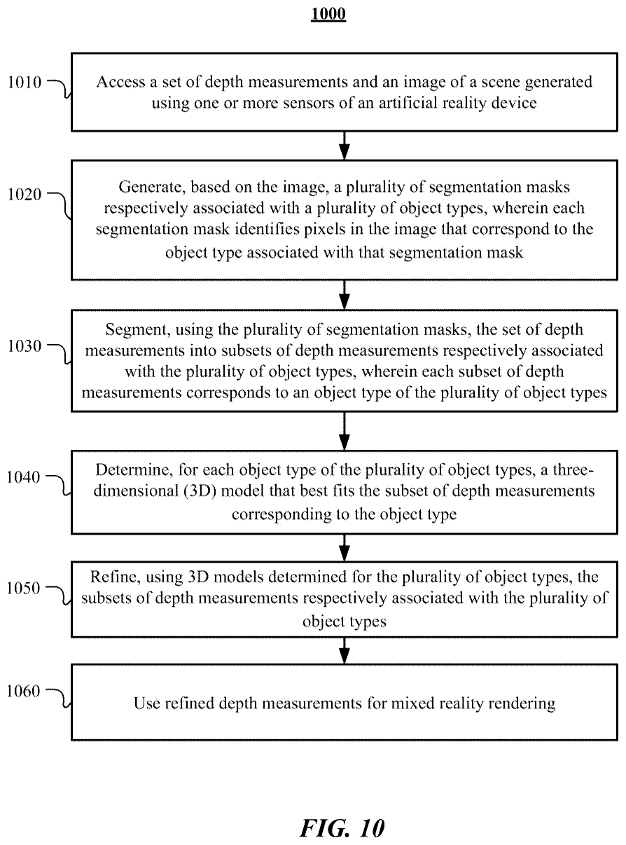

FIG. 10 illustrates an example method 1000 for generating reliable and/or refined depth measurements for mixed reality rendering, in accordance with particular embodiments. The method 1000 may begin at step 1010, where a computing system (e.g., the computer 108 or computer system 1200) associated with an artificial reality system (e.g., the artificial reality system 100) may access a set of depth measurements and an image (e.g., brightness image) of a scene generated using one or more sensors of an artificial reality device. The artificial reality device may be a mixed reality headset. In some embodiments, the one or more sensors discussed herein are time-of-flight sensors and the image is an output of the time-of-flight sensor. In some embodiments, the one or more sensors are depth sensors, which are capable of producing depth measurements and brightness images. In other embodiments, the one or more sensors may be a pair of stereo cameras (e.g., cameras 105A-105B) and the image may be output by one camera of the pair of stereo cameras. When the sensors are stereo cameras, depth measurements may be obtained by comparing the stereo images.

At step 1020, the computing system may generate, based on the image, a plurality of segmentation masks (e.g., segmentation masks 908) respectively associated with a plurality of object types. Each segmentation mask identifies pixels in the image that correspond to the object type associated with that segmentation mask. In particular embodiments, a ML-based segmentation model may be used to perform the segmentation discussed herein.

At step 1030, the computing system may segment, using the plurality of segmentation masks, the set of depth measurements (e.g., depth measurements 902) into subsets of depth measurements respectively associated with the plurality of object types (e.g., subsets of depth measurements 910). Each subset of depth measurements may correspond to an object type of the plurality of object types. In particular embodiments, the object type is at least one of planes, people, or static objects in the scene observed over a period of time.

At step 1040, the computing system may determine, for each object type of the plurality of object types, a three-dimensional (3D) model that best fits the subset of depth measurements corresponding to the object type. In particular embodiments, determining, for each object type of the plurality of object types, the 3D model that best fits the subset of depth measurements corresponding to the object type may include, for example, (1) determining parameters (e.g., shape, size, length, width, thickness, height, pose, etc.) of the object type at a current time instance, (2) selecting a particular 3D model from a plurality of 3D models that corresponds to the object type, and (3) generating the 3D model for the object type by optimizing the particular 3D model according to the parameters of the object type at the current time instance and such that generated 3D model best fits the subset of depth measurements corresponding to the object type. In an embodiment where the object type is a complex object type or category, the parameters of such a complex object type may be determined using a machine learning model, such as a variational autoencoder (VAE).

At step 1050, the computing system may refine, using 3D models determined for the plurality of object types, the subsets of depth measurements respectively associated with the plurality of object types. In particular embodiments, the 3D models are pre-generated models by one or more components (e.g., components 922a-922n) associated with the plurality of object types. The one or more components may generate the 3D models based on tracking object geometry of the plurality of object types over a period of time. In particular embodiments, refining the subsets of depth measurements using the 3D models determined for the plurality of object types may include, for example, replacing, for each object type, the subset of depth measurements corresponding to the object type with depth information (e.g., depth measurements, object geometry) represented by the 3D model associated with the object type. The depth information represented by the 3D model associated with the object type is relatively more accurate than the subset of depth measurements corresponding to the object type.

At step 1060, the computing system may use refined depth measurements generated using the 3D models for one or more downstream artificial reality applications, such as for mixed reality rendering. In particular embodiments, the mixed reality rendering may include, for example and without limitation, passthrough rendering, occlusion detection or rendering, or light rendering, etc.

The computing system may continue to receive subsequent depth measurements of the scene captured over a period of time. In particular embodiments, the computing system may apply a stabilization filter to the 3D models to stabilize the subsequent depth measurements captured over the period of time. For example, the computing system may use a Kalman filter to stabilize the depth measurements captured over the period of time, as discussed elsewhere herein.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for generating reliable and/or refined depth measurements for use with one or more downstream artificial reality applications, including the particular steps of the method of FIG. 10, this disclosure contemplates any suitable method for generating reliable and/or refined depth measurements for use with one or more downstream artificial reality applications, including any suitable steps, which may include a subset of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

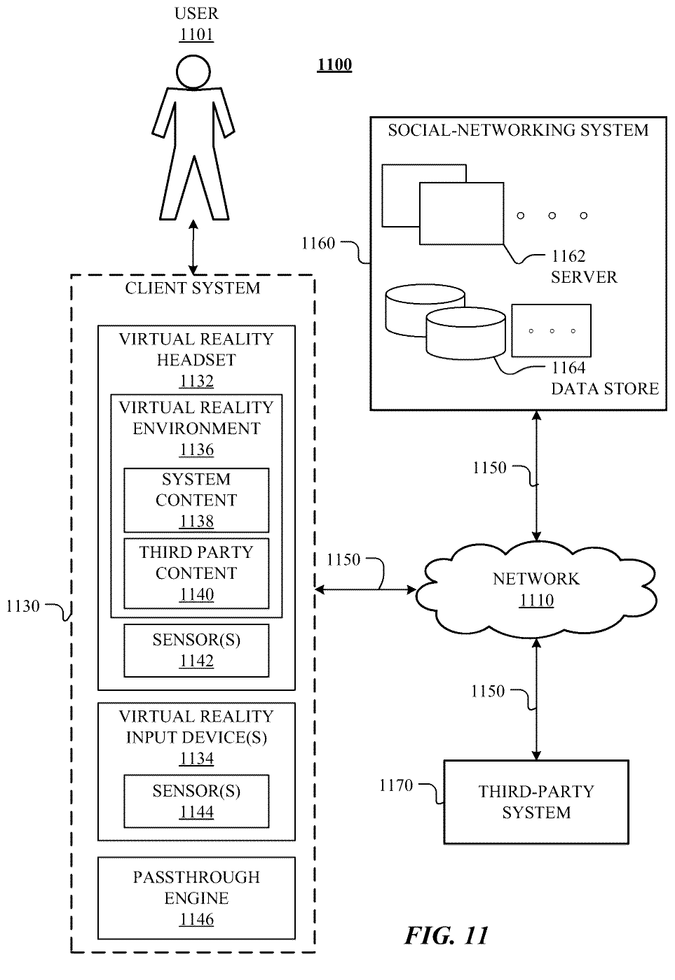

FIG. 11 illustrates an example network environment 1100 associated with an artificial reality system. Although FIG. 11 may be illustrated with a virtual reality system, this example network environment 1100 may include one or more other artificial reality systems, such as mixed reality systems, augmented reality systems, etc. Network environment 1100 includes a user 1101 interacting with a client system 1130, a social-networking system 1160, and a third-party system 1170 connected to each other by a network 1110. Although FIG. 11 illustrates a particular arrangement of a user 1101, a client system 1130, a social-networking system 1160, a third-party system 1170, and a network 1110, this disclosure contemplates any suitable arrangement of a user 1101, a client system 1130, a social-networking system 1160, a third-party system 1170, and a network 1110. As an example and not by way of limitation, two or more of a user 1101, a client system 1130, a social-networking system 1160, and a third-party system 1170 may be connected to each other directly, bypassing a network 1110. As another example, two or more of a client system 1130, a social-networking system 1160, and a third-party system 1170 may be physically or logically co-located with each other in whole or in part. Moreover, although FIG. 11 illustrates a particular number of users 1101, client systems 1130, social-networking systems 1160, third-party systems 1170, and networks 1110, this disclosure contemplates any suitable number of client systems 1130, social-networking systems 1160, third-party systems 1170, and networks 1110. As an example and not by way of limitation, network environment 1100 may include multiple users 1101, client systems 1130, social-networking systems 1160, third-party systems 1170, and networks 1110.

This disclosure contemplates any suitable network 1110. As an example and not by way of limitation, one or more portions of a network 1110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 1110 may include one or more networks 1110.

Links 1150 may connect a client system 1130, a social-networking system 1160, and a third-party system 1170 to a communication network 1110 or to each other. This disclosure contemplates any suitable links 1150. In particular embodiments, one or more links 1150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1150, or a combination of two or more such links 1150. Links 1150 need not necessarily be the same throughout a network environment 1100. One or more first links 1150 may differ in one or more respects from one or more second links 1150.

In particular embodiments, a client system 1130 may be an electronic device including hardware, software, or embedded logic components or a combination of two or more such components and capable of carrying out the appropriate functionalities implemented or supported by a client system 1130. As an example and not by way of limitation, a client system 1130 may include a computer system such as a desktop computer, notebook or laptop computer, netbook, a tablet computer, e-book reader, GPS device, camera, personal digital assistant (PDA), handheld electronic device, cellular telephone, smartphone, virtual reality or mixed reality headset and controllers, other suitable electronic device, or any suitable combination thereof. This disclosure contemplates any suitable client systems 1130. A client system 1130 may enable a network user at a client system 1130 to access a network 1110. A client system 1130 may enable its user to communicate with other users at other client systems 1130. A client system 1130 may generate a virtual reality environment or a mixed reality environment for a user to interact with content.

In particular embodiments, a client system 1130 may include a virtual reality (or augmented reality or mixed reality) headset 1132, and virtual reality input device(s) 1134, such as a virtual reality controller. A user at a client system 1130 may wear the virtual reality headset 1132 and use the virtual reality input device(s) to interact with a virtual reality environment 1136 generated by the virtual reality headset 1132. Although not shown, a client system 1130 may also include a separate processing computer and/or any other component of a virtual reality system. A virtual reality headset 1132 may generate a virtual reality environment 1136, which may include system content 1138 (including but not limited to the operating system), such as software or firmware updates and also include third-party content 1140, such as content from applications or dynamically downloaded from the Internet (e.g., web page content). A virtual reality headset 1132 may include sensor(s) 1142, such as accelerometers, gyroscopes, magnetometers to generate sensor data that tracks the location of the headset device 1132. The headset 1132 may also include eye trackers for tracking the position of the user's eyes or their viewing directions. The client system 1130 may use data from the sensor(s) 1142 to determine velocity, orientation, and gravitation forces with respect to the headset. Virtual reality input device(s) 1134 may include sensor(s) 1144, such as accelerometers, gyroscopes, magnetometers, and touch sensors to generate sensor data that tracks the location of the input device 1134 and the positions of the user's fingers. The client system 1130 may make use of outside-in tracking, in which a tracking camera (not shown) is placed external to the virtual reality headset 1132 and within the line of sight of the virtual reality headset 1132. In outside-in tracking, the tracking camera may track the location of the virtual reality headset 1132 (e.g., by tracking one or more infrared LED markers on the virtual reality headset 1132). Alternatively or additionally, the client system 1130 may make use of inside-out tracking, in which a tracking camera (not shown) may be placed on or within the virtual reality headset 1132 itself. In inside-out tracking, the tracking camera may capture images around it in the real world and may use the changing perspectives of the real world to determine its own position in space.

In particular embodiments, client system 1130 (e.g., an HMD) may include a passthrough engine 1146 to provide the passthrough feature described herein, and may have one or more add-ons, plug-ins, or other extensions. A user at client system 1130 may connect to a particular server (such as server 1162, or a server associated with a third-party system 1170). The server may accept the request and communicate with the client system 1130.

Third-party content 1140 may include a web browser and may have one or more add-ons, plug-ins, or other extensions. A user at a client system 1130 may enter a Uniform Resource Locator (URL) or other address directing a web browser to a particular server (such as server 1162, or a server associated with a third-party system 1170), and the web browser may generate a Hyper Text Transfer Protocol (HTTP) request and communicate the HTTP request to server. The server may accept the HTTP request and communicate to a client system 1130 one or more Hyper Text Markup Language (HTML) files responsive to the HTTP request. The client system 1130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation combinations of markup language and scripts, and the like. Herein, reference to a web interface encompasses one or more corresponding source files (which a browser may use to render the web interface) and vice versa, where appropriate.

In particular embodiments, the social-networking system 1160 may be a network-addressable computing system that can host an online social network. The social-networking system 1160 may generate, store, receive, and send social-networking data, such as, for example, user-profile data, concept-profile data, social-graph information, or other suitable data related to the online social network. The social-networking system 1160 may be accessed by the other components of network environment 1100 either directly or via a network 1110. As an example and not by way of limitation, a client system 1130 may access the social-networking system 1160 using a web browser of a third-party content 1140, or a native application associated with the social-networking system 1160 (e.g., a mobile social-networking application, a messaging application, another suitable application, or any combination thereof) either directly or via a network 1110. In particular embodiments, the social-networking system 1160 may include one or more servers 1162. Each server 1162 may be a unitary server or a distributed server spanning multiple computers or multiple datacenters. Servers 1162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 1162 may include hardware, software, or embedded logic components or a combination of two or more such components for carrying out the appropriate functionalities implemented or supported by server 1162. In particular embodiments, the social-networking system 1160 may include one or more data stores 1164. Data stores 1164 may be used to store various types of information. In particular embodiments, the information stored in data stores 1164 may be organized according to specific data structures. In particular embodiments, each data store 1164 may be a relational, columnar, correlation, or other suitable database. Although this disclosure describes or illustrates particular types of databases, this disclosure contemplates any suitable types of databases. Particular embodiments may provide interfaces that enable a client system 1130, a social-networking system 1160, or a third-party system 1170 to manage, retrieve, modify, add, or delete, the information stored in data store 1164.

In particular embodiments, the social-networking system 1160 may store one or more social graphs in one or more data stores 1164. In particular embodiments, a social graph may include multiple nodes—which may include multiple user nodes (each corresponding to a particular user) or multiple concept nodes (each corresponding to a particular concept)—and multiple edges connecting the nodes. The social-networking system 1160 may provide users of the online social network the ability to communicate and interact with other users. In particular embodiments, users may join the online social network via the social-networking system 1160 and then add connections (e.g., relationships) to a number of other users of the social-networking system 1160 whom they want to be connected to. Herein, the term “friend” may refer to any other user of the social-networking system 1160 with whom a user has formed a connection, association, or relationship via the social-networking system 1160.

In particular embodiments, the social-networking system 1160 may provide users with the ability to take actions on various types of items or objects, supported by the social-networking system 1160. As an example and not by way of limitation, the items and objects may include groups or social networks to which users of the social-networking system 1160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 1160 or by an external system of a third-party system 1170, which is separate from the social-networking system 1160 and coupled to the social-networking system 1160 via a network 1110.

In particular embodiments, the social-networking system 1160 may be capable of linking a variety of entities. As an example and not by way of limitation, the social-networking system 1160 may enable users to interact with each other as well as receive content from third-party systems 1170 or other entities, or to allow users to interact with these entities through an application programming interfaces (API) or other communication channels.

In particular embodiments, a third-party system 1170 may include one or more types of servers, one or more data stores, one or more interfaces, including but not limited to APIs, one or more web services, one or more content sources, one or more networks, or any other suitable components, e.g., that servers may communicate with. A third-party system 1170 may be operated by a different entity from an entity operating the social-networking system 1160. In particular embodiments, however, the social-networking system 1160 and third-party systems 1170 may operate in conjunction with each other to provide social-networking services to users of the social-networking system 1160 or third-party systems 1170. In this sense, the social-networking system 1160 may provide a platform, or backbone, which other systems, such as third-party systems 1170, may use to provide social-networking services and functionality to users across the Internet.

In particular embodiments, a third-party system 1170 may include a third-party content object provider. A third-party content object provider may include one or more sources of content objects, which may be communicated to a client system 1130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 1160 also includes user-generated content objects, which may enhance a user's interactions with the social-networking system 1160. User-generated content may include anything a user can add, upload, send, or “post” to the social-networking system 1160. As an example and not by way of limitation, a user communicates posts to the social-networking system 1160 from a client system 1130. Posts may include data such as status updates or other textual data, location information, photos, videos, links, music or other similar data or media. Content may also be added to the social-networking system 1160 by a third-party through a “communication channel,” such as a newsfeed or stream.

In particular embodiments, the social-networking system 1160 may include a variety of servers, sub-systems, programs, modules, logs, and data stores. In particular embodiments, the social-networking system 1160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 1160 may also include suitable components such as network interfaces, security mechanisms, load balancers, failover servers, management-and-network-operations consoles, other suitable components, or any suitable combination thereof. In particular embodiments, the social-networking system 1160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 1160 to one or more client systems 1130 or one or more third-party systems 1170 via a network 1110. The web server may include a mail server or other messaging functionality for receiving and routing messages between the social-networking system 1160 and one or more client systems 1130. An API-request server may allow a third-party system 1170 to access information from the social-networking system 1160 by calling one or more APIs. An action logger may be used to receive communications from a web server about a user's actions on or off the social-networking system 1160. In conjunction with the action log, a third-party-content-object log may be maintained of user exposures to third-party-content objects. A notification controller may provide information regarding content objects to a client system 1130. Information may be pushed to a client system 1130 as notifications, or information may be pulled from a client system 1130 responsive to a request received from a client system 1130. Authorization servers may be used to enforce one or more privacy settings of the users of the social-networking system 1160. A privacy setting of a user determines how particular information associated with a user can be shared. The authorization server may allow users to opt in to or opt out of having their actions logged by the social-networking system 1160 or shared with other systems (e.g., a third-party system 1170), such as, for example, by setting appropriate privacy settings. Third-party-content-object stores may be used to store content objects received from third parties, such as a third-party system 1170. Location stores may be used for storing location information received from client systems 1130 associated with users. Advertisement-pricing modules may combine social information, the current time, location information, or other suitable information to provide relevant advertisements, in the form of notifications, to a user.

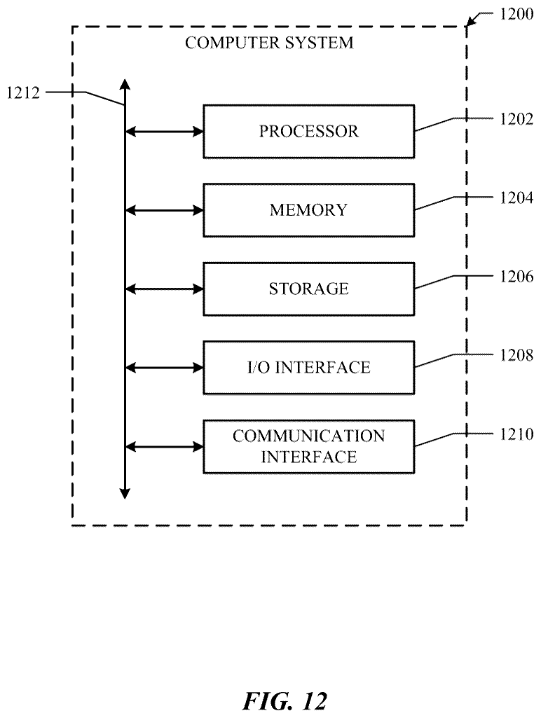

FIG. 12 illustrates an example computer system 1200. In particular embodiments, one or more computer systems 1200 perform one or more steps of one or more processes, algorithms, techniques, or methods described or illustrated herein. In particular embodiments, one or more computer systems 1200 provide functionality described or illustrated herein. In particular embodiments, software running on one or more computer systems 1200 performs one or more steps of one or more methods described or illustrated herein or provides functionality described or illustrated herein. Particular embodiments include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In particular embodiments, memory 1204 includes main memory for storing instructions for processor 1202 to execute or data for processor 1202 to operate on. As an example and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In particular embodiments, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory, this disclosure contemplates any suitable memory.

In particular embodiments, storage 1206 includes mass storage for data or instructions. As an example and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In particular embodiments, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In particular embodiments, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In particular embodiments, communication interface 1210 includes hardware, software, or both providing one or more interfaces for communication (such as, for example, packet-based communication) between computer system 1200 and one or more other computer systems 1200 or one or more networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing a set of depth measurements and an image of a scene generated using one or more sensors of an artificial reality device;
generating, based on the image, a plurality of segmentation masks respectively associated with a plurality of object types, wherein each segmentation mask identifies pixels in the image that correspond to the object type associated with that segmentation mask;
segmenting, using the plurality of segmentation masks, the set of depth measurements into subsets of depth measurements respectively associated with the plurality of object types, wherein each subset of depth measurements corresponds to an object type of the plurality of object types;
determining, for each object type of the plurality of object types, a three-dimensional (3D) model that best fits the subset of depth measurements corresponding to the object type;
refining, using 3D models determined for the plurality of object types, the subsets of depth measurements respectively associated with the plurality of object types; and
using refined depth measurements for mixed reality rendering.

2. The method of claim 1, wherein refining the subsets of depth measurements using 3D models determined for the plurality of object types comprises:
replacing, for each object type, the subset of depth measurements corresponding to the object type with depth information represented by the 3D model associated with the object type, wherein the depth information represented by the 3D model associated with the object type is relatively more accurate than the subset of depth measurements corresponding to the object type.

3. The method of claim 1, wherein determining, for each object type of the plurality of object types, the 3D model that best fits the subset of depth measurements corresponding to the object type comprises:
determining parameters of the object type at a current time instance;
selecting a particular 3D model from a plurality of 3D models that corresponds to the object type; and
generating the 3D model for the object type by optimizing the particular 3D model according to the parameters of the object type at the current time instance and such that generated 3D model best fits the subset of depth measurements corresponding to the object type.

4. The method of claim 3, wherein:
the object type is a complex object type; and
the parameters of the object type are determined using a machine learning model.

5. The method of claim 4, wherein the machine learning model is a variational autoencoder (VAE).

6. The method of claim 3 wherein the parameters of the object type comprise one or more of:
a shape;
a size;
a length;
a width;
a thickness; or
a height.

7. The method of claim 1, wherein the mixed reality rendering comprises one or more of:
passthrough rendering;
occlusion detection or rendering; or
light rendering.

8. The method of claim 1, wherein the object type is at least one of planes, people, or static objects in the scene observed over a period of time.

9. The method of claim 1, wherein the 3D models are pre-generated models by one or more components associated with the plurality of object types, and wherein the one or more components generate the 3D models based on tracking object geometry of the plurality of object types over a period of time.

10. The method of claim 1, further comprising:
receiving subsequent depth measurements of the scene captured over a period of time; and
using a stabilization filter to stabilize the subsequent depth measurements captured over the period of time.

11. The method of claim 10, wherein the stabilization filter is a Kalman filter.

12. The method of claim 1, wherein the segmentation masks are generated using a machine learning (ML) based segmentation model.

13. The method of claim 1, wherein the one or more sensors comprise a time-of-flight sensor, and the image is an output of the time-of-flight sensor.

14. The method of claim 1, wherein the one or more sensors comprise a pair of stereo cameras, and the image is output by one camera of the pair of stereo cameras.

15. One or more computer-readable non-transitory storage media embodying software that is operable when executed to:
access a set of depth measurements and an image of a scene generated using one or more sensors of an artificial reality device;
generate, based on the image, a plurality of segmentation masks respectively associated with a plurality of object types, wherein each segmentation mask identifies pixels in the image that correspond to the object type associated with that segmentation mask;
segment, using the plurality of segmentation masks, the set of depth measurements into subsets of depth measurements respectively associated with the plurality of object types, wherein each subset of depth measurements corresponds to an object type of the plurality of object types;
determine, for each object type of the plurality of object types, a three-dimensional (3D) model that best fits the subset of depth measurements corresponding to the object type;
refine, using 3D models determined for the plurality of object types, the subsets of depth measurements respectively associated with the plurality of object types; and
use refined depth measurements for mixed reality rendering.

16. The one or more computer-readable non-transitory storage media of claim 15, wherein to refine the subsets of depth measurements using the 3D models determined for the plurality of object types, the software is further operable when executed to:
replace, for each object type, the subset of depth measurements corresponding to the object type with depth information represented by the 3D model associated with the object type, wherein the depth information represented by the 3D model associated with the object type is relatively more accurate than the subset of depth measurements corresponding to the object type.

17. The one or more computer-readable non-transitory storage media of claim 15, wherein to determine, for each object type of the plurality of object types, the 3D model that best fits the subset of depth measurements corresponding to the object type, the software is further operable when executed to:
determine parameters of the object type at a current time instance;
select a particular 3D model from a plurality of 3D models that corresponds to the object type; and
generate the 3D model for the object type by optimizing the particular 3D model according to the parameters of the object type at the current time instance and such that generated 3D model best fits the subset of depth measurements corresponding to the object type.

18. An artificial reality device comprising:
one or more sensors;
one or more processors; and
one or more computer-readable non-transitory storage media coupled to one or more of the processors and comprising instructions operable when executed by the one or more of the processors to cause the artificial reality device to:
access a set of depth measurements and an image of a scene generated using the one or more sensors of the artificial reality device;
generate, based on the image, a plurality of segmentation masks respectively associated with a plurality of object types, wherein each segmentation mask identifies pixels in the image that correspond to the object type associated with that segmentation mask;
segment, using the plurality of segmentation masks, the set of depth measurements into subsets of depth measurements respectively associated with the plurality of object types, wherein each subset of depth measurements corresponds to an object type of the plurality of object types;
determine, for each object type of the plurality of object types, a three-dimensional (3D) model that best fits the subset of depth measurements corresponding to the object type;
refine, using 3D models determined for the plurality of object types, the subsets of depth measurements respectively associated with the plurality of object types; and
use refined depth measurements for mixed reality rendering.

19. The artificial reality device of claim 18, wherein to refine the subsets of depth measurements using the 3D models determined for the plurality of object types, the instructions are further operable when executed by the one or more of the processors to cause the artificial reality device to:
replace, for each object type, the subset of depth measurements corresponding to the object type with depth information represented by the 3D model associated with the object type, wherein the depth information represented by the 3D model associated with the object type is relatively more accurate than the subset of depth measurements corresponding to the object type.

20. The artificial reality device of claim 18, wherein to determine, for each object type of the plurality of object types, the 3D model that best fits the subset of depth measurements corresponding to the object type, the instructions are further operable when executed by the one or more of the processors to cause the artificial reality device to:
determine parameters of the object type at a current time instance;
select a particular 3D model from a plurality of 3D models that corresponds to the object type; and
generate the 3D model for the object type by optimizing the particular 3D model according to the parameters of the object type at the current time instance and such that generated 3D model best fits the subset of depth measurements corresponding to the object type.
